(19) United States
(12) Patent Application Publication
(10) Pub. No.: US 2004/0234089 A1
(43) Pub. Date: Nov. 25, 2004

(54) Hearing aid

(75) Inventors: Raphael Rembrand, Kiriat Tivon (IL); Yaacov Aboody, Hod-Hasharon (IL)

Correspondence Address: MERCHANT & GOULD PC, P.O. BOX 2903, MINNEAPOLIS, MN, 55402-0903, US

(73) Assignee: NEAT IDEAS N.V., Willemstad (NL)

(21) Appl. No.: 10/607,891

(22) Filed: Jun. 27, 2003

Related U.S. Application Data
(63) Continuation-in-part of application No. 10/442,495, filed on May 20, 2003.

(51) Int. Cl. H04R 29/00; H04R 25/00

(52) U.S. Cl. 381/312; 381/60; 381/316; 381/320; 381/317

(57) ABSTRACT

System for enhancing the hearing of certain sounds, the system including an electro-acoustic transducer for producing sounds in the Vicinity of an ear, according to signals provided thereto, and a compensatory signal generator coupled with the electro-acoustic transducer, the compensatory signal generator producing a compensatory signal, according to at least a portion of a compensatory waveform, the compensatory waveform being determined according to ear otoacoustic emissions, the compensatory signal being employed to enhance the hearing, the compensatory signal generator providing the compensatory signal to the electro-acoustic transducer.

### FIELD OF THE DISCLOSED TECHNIQUE

The disclosed technique relates to hearing aids in general, and in particular, to methods and systems to enhance hearing in one or more selected frequency ranges.

### BACKGROUND OF THE DISCLOSED TECHNIQUE

Hearing impairment is divided to at least two categories, i.e., conductive impairment and sensorineural impairment. Conductive impairment is due to a mechanical defect in the middle ear, which prevents sound waves to reach the inner ear. Sensorineural impairment is due to a defect in the auditory nervous system (e.g., damage to the cochlea or portions thereof, defective auditory neurons or diminished sensitivity of the auditory nerves), where the sound waves reach the inner ear, but are not transmitted further to the brain for perception.

Sensorineural impairment is a case where the sensational level of the perceived speech is diminished, in one or more frequency ranges. This patient might hear normal speech as a whisper, or not hear the speech at all, wherein the comprehension level is rather low.

In a normal ear, the ambient sound causes the tympanic membrane (i.e., the eardrum) to vibrate. The ossicular chain (i.e., malleus, incus and stapes) which is located between the tympanic membrane and the oval window, mechanically transmits these vibrations to the fluid within the cochlea, which in turn generates a traveling wave in the fluid. These waves cause the inner hair cells which are part of Corti's organ, to vibrate, thereby causing the auditory neurons connected to these inner hair cells to fire and convey sensory information respective of the ambient sound, to the brain stem. Thus, the inner hair cells are regarded as mechanoelectric transducers.

The Corti's organ includes also a plurality of outer hair cells. The cranial olivary nucleus which is part of the brain stem, transmits an electric signal respective of the detected ambient sound, to the cell membrane of the outer hair cells, via the olivocochlear tract. The electric signal causes the outer hair cells to vibrate, thereby feeding back the energy into the traveling wave. This positive feedback mechanism reinforces the vibrations produced in the inner hair cells and improves the detection of sound by the brain. Thus, the outer hair cells are regarded as electromechanical transducers.

The cranial olivary nucleus transmits signals to the cell membrane of, the outer hair cells, even in the absence of any ambient sound. The energy produced by the outer hair cells is known in the art as otoacoustic emissions (OAE) whose amplitude in a normal subject amounts to several tens of decibels. According to numerous research, the presence of otoacoustic emissions drops as a function of hearing loss (e.g., Lionel Collet, Arch Otolaryngol Head Neck Surgery, Volume 115, September 1989). Thus, the inability to detect sound in a selected frequency range is attributed to inability of a set of outer hair cells in a selected section of the Corti's organ to vibrate mechanically and emit a respective OAE.

The otoacoustic emissions are defined and measured in various ways. Spontaneous otoacoustic emissions (SOAE) are low level, tonal signals which are measured in the ear canal in the absence of any known stimulus. SOAE is usually inaudible to the person whose ear is being detected. Transient-evoked otoacoustic emissions (TEOAE) are emissions which are elicited by brief stimuli, such as clicks or tone bursts. TEOAE are present in persons with normal hearing, are highly non-linear and support the fact that otoacoustic emissions arise from the activity of the outer hair cells. Distortion product otoacoustic emissions (DPOAE) are tones produced in the ear in response to two simultaneous pure-tone stimuli (i.e., primary tones). The lower frequency pure-tone stimulus is termed the f1 primary and the higher frequency pure-tone stimulus, the f2 primary. The most frequently measured distortion product is at the frequency of 2f1-f2. Normal speech is characterized by a range of frequencies between 250 Hz and 2000 Hz and a range of amplitudes between 15 and 30 dB. The normal speech spectrum is known in the art as speech shape noise (SSN) and in terms of frequencies it is similar to the shape of a normal DPOAE response curve.

Various methods and systems are available to improve comprehension in a patient who is unable to detect sound in a selected frequency range. For example, in one type of hearing aid which is worn in the vicinity of the outer ear, the ambient sound is amplified along a continuous range of frequencies which includes the impaired frequency ranges. In this type of hearing aid, the comprehension is improved in the impaired frequency ranges. However, the amplitude of the sound in the intact frequency ranges is excessively increased, thereby causing discomfort and undue distraction to the patient.

U.S. Pat. No. 6,387,039 issued to Moses and entitled “Implantable Hearing Aid”, is directed to a hearing aid which can be implanted in the tympanic membrane of the ear of a person. The hearing aid includes a microphone, and amplifier, a speaker and a power source. The amplifier is coupled to the microphone and to the speaker. The power source is coupled to the microphone, the amplifier and to the speaker.

The microphone receives sound waves from the outer ear through the ear canal and converts the sound waves into electrical or electromagnetic signals. The amplifier amplifies the signals and the speaker converts the amplified signal to amplified sound waves. The amplified sound waves impact the tympanic membrane and vibrate the assicular chain (i.e., the malleus, incus and stapes), thereby vibrating the hair cells and stimulating the auditory neurons.

U.S. Pat. No. 6,275,596 issued to Fretz, et al., and entitled “Open Ear Canal Hearing Aid System”, is directed to a hearing aid for correcting sound at a predetermined frequency and amplitude. The hearing aid includes an ear canal tube, a hearing aid tube, a case, a barb and a tip. The case includes a microphone, a preamplifier, a receiver, a detector and a compressor. The receiver is an output device, such as a loudspeaker.

The ear canal tube is connected to the hearing aid tube. The hearing aid tube is connected to the case. The case is designed to fit behind the ear. The barb is attached to one side of the ear canal tube and the barb lodges behind the tragus (i.e., part of the external ear), for keeping the ear canal tube inside the ear canal. The tip fits over the ear canal tube. The tip is flared in order to provide acoustic matching of the sound delivered through the ear canal tube to the ear canal.

The preamplifier is connected to the microphone, the detector and to the compressor. The detector is connected to the compressor. The receiver is connected to the hearing aid tube and to the compressor. The preamplifier amplifies the sound received by the microphone and the preamplifier provides a signal to the detector and to the compressor. The detector detects whether the received sounds are within a predetermined frequency and amplitude range. The compressor adjusts the gain of the received sounds according to the output of the detector. The receiver converts the processed signals output from the compressor, to audible sounds and the receiver delivers these audible sounds to the ear canal tube.

International Publication No. WO 99/07302 entitled “Apparatus and Method for an Auditory Stimulator”, is directed to a tinnitus retraining instrument (TRI) device for reducing the effects of tinnitus. The TRI device includes two retention arms, battery contacts, a face-plate, a noise source, an amplifier, a receiver and an acoustic horn. The face-plate includes a volume control and a battery door. The TRI device is placed within the external ear and the two retention arms keep the TRI device such that the external ear canal is completely open in the inferior portion thereof. In this manner, the TRI device wearer hears the ambient sound as well as the sound produced by the TRI device.

The battery contacts connect power to the noise source, to the amplifier and to the receiver. The acoustic horn is connected to the receiver. The noise source generates a noise to immerse the tinnitus head noise below audibility. The amplifier amplifies the signal received from the noise source and the receiver produces a noise and delivers the noise to the acoustic horn. The level of the transmitted noise can be adjusted by the volume control.

International Publication No. WO 99/41938 entitled “Speech Processing System and Method Using Pseudo-spontaneous Stimulation”, is directed to an inner ear stimulation system which produces random spike patterns in auditory nerve fibers, wherein these random spike patterns mimic the spontaneous neural activation of the auditory nerve. The inner ear stimulation system includes an implantable system and an external system. The inner ear stimulation system includes a stimulation unit and an electrode array. The external system includes a microphone, a pseudo spontaneous' signal generator, a signal generator, a controller, a selection unit, a power source and a head piece. The signal generator includes a battery. The head piece is an ear piece which is worn like a hearing aid. The external system is coupled to the head piece.

The signal generator is coupled to the microphone, the pseudo-spontaneous signal generator, and to the stimulation unit. The controller is coupled to the selection unit and to the power source. The electrode array is implanted in the cochlea of the patient and the stimulation unit is coupled to the auditory nerve, via the electrode array. Each set of electrodes of the electrode array stimulates a specific site of the cochlea, in order to evoke neural activity which this specific site produces in a normal subject.

The controller controls the signal generator to produce an electrical signal which is delivered to the stimulation unit. The signal generator produces the electrical signal by adding a signal received from the pseudo spontaneous signal generator to another signal received from the microphone. The signal generator varies the frequency, amplitude and the pulse width of the electrical signal delivered to the stimulation unit. At installation and periodically thereafter, the hearing pattern of the patient is monitored and the selection unit selects from a plurality of pseudo spontaneous driving signals to modify the electrical signal which the signal generator provides the stimulation unit.

U.S. Pat. No. 5,930,373 issued to Shashoua et al., and entitled “Method and System for Enhancing Quality of Sound Signal”, is directed to a system for conveying to a listener a pseudo low frequency psychoacoustic sensation of a sound signal. The system includes a residue harmonics generator, a first loudness analyzer, a second loudness analyzer, a control logic and a control application. The control logic is connected with the first loudness analyzer, the second loudness analyzer and with the control application. The control application is connected with the second loudness analyzer and with the residue harmonics generator.

The residue harmonics generator receives a low frequency signal, produces a residue harmonics signal and provides the residue harmonics signal to the second loudness analyzer and to the control application. The second loudness analyzer also receives a high frequency signal. The residue harmonics signal includes at least three consecutive harmonics from among the first group of harmonics. The first loudness analyzer receives the high frequency signal and the low frequency signal.

The first loudness analyzer and the second loudness analyzer produce information respective of the entire audio signal which is presented to an ear, by analyzing the low frequency signal, as well as the residue harmonics signal. The first loudness analyzer and the second loudness analyzer provide this information to the control logic. The control logic matches the loudness of the residue harmonics signal with that of the input low frequency signal.

Pseudo low frequency psychoacoustic sensation (pseudo-LFPS) is a sensation that results from the original sound signal and which attempts to resemble the low frequency psychoacoustic sensation. Loudness matching attribute is an attribute by which two sound signals are judged to have the same loudness dynamics. A psychoacoustic alternative signal is a signal which conveys to the listener a pseudo-LFPS. The system implements the loudness matching which is desired for the psychoacoustic alternative signal. The system matches the loudness of the low frequency range of interest of the sound signal, with the psychoacdustic alternative signal.

### SUMMARY OF THE DISCLOSED TECHNIQUE

It is an object of the disclosed technique to provide a novel method and system for enhancing the hearing of either a normal ear or a hearing impaired ear.

In accordance with the disclosed technique, there is thus provided a system for enhancing the hearing of certain sounds. The system includes an electro-acoustic transducer, and a compensatory signal generator. The electro-acoustic transducer produces sounds in the vicinity of an ear, according to signals provided to the electro-acoustic transducer.

The compensatory signal generator is coupled with the electro-acoustic transducer. The compensatory signal generator produces a compensatory signal according to at least a portion of a compensatory waveform, wherein the compensatory waveform is determined according to ear otoacoustic emissions. The compensatory signal generator provides the compensatory signal to the electro-acoustic transducer and the electro-acoustic transducer produces the sounds in the vicinity of the ear, thereby enhancing the hearing of certain sounds by the ear.

In accordance with another aspect of the disclosed technique, there is thus provided a method for enhancing the hearing of certain sounds. The method includes the procedures of producing a compensatory signal according to at least a portion of a compensatory waveform, and producing a compensatory sound in the vicinity of the ear, according to the compensatory signal. The compensatory waveform is determined according to the ear otoacoustic emissions.

In accordance with a further aspect of the disclosed technique, there is thus provided a method for enhancing the hearing of certain sounds. The method includes the procedures of producing a compensatory signal for at least selected ones of a plurality of predetermined bands, and applying modification triggering criteria corresponding to each of the selected predetermined bands.

The method further includes a procedure of modifying the ambient sound signal corresponding to each of the selected predetermined bands, according to the compensatory signal, when the modification triggering criteria apply, thereby producing a modified signal. The compensatory signal possesses characteristics for enhancing hearing of sounds within the selected predetermined bands. The modification triggering criteria are applied according to at least a respective portion of an ambient sound signal.

### BRIEF DESCRIPTION OF THE DRAWINGS

The disclosed technique will be understood and appreciated more fully from the following detailed description taken in conjunction with the drawings in which:

FIG. 1 is a schematic illustration of a system for enhancing hearing in a selected range of frequencies, constructed and operative in accordance with an embodiment of the disclosed technique;

FIG. 2A is a schematic graph of a normal hearing spectrum of a normally hearing ear and a: normal OAE waveform of the normally hearing ear;

FIG. 2B is a schematic graph of an abnormal-hearing spectrum of a hearing impaired ear and an abnormal-OAE waveform of the hearing impaired ear;

FIG. 2C is a schematic graph of the abnormal-OAE waveform of FIG. 2B and a compensatory OAE waveform, which when added together, result in the normal hearing spectrum of FIG. 2A;

FIG. 2D is a schematic graph of a plurality of waveforms illustrating a case to bring about uniform response of an ear in substantially the entire audible range of frequencies;

FIG. 2E is a schematic graph of a plurality of waveforms illustrating a case to improve hearing in a selected range of frequencies;

FIG. 3 is a schematic illustration of a system for enhancing hearing in a selected range of frequencies, constructed and operative in accordance with another embodiment of the disclosed technique;

FIG. 4A is a schematic illustration of a system for enhancing hearing in a selected range of frequencies, constructed and operative in accordance with a further embodiment of the disclosed technique;

FIG. 4B is a schematic graph of a combined signal, which is a combination of a compensatory signal produced by a compensatory signal generator of the system of FIG. 4A and an ambient sound signal;

FIG. 5 is a schematic illustration of a system for enhancing hearing in a selected range of frequencies, constructed and operative in accordance with another embodiment of the disclosed technique;

FIG. 6 is a schematic illustration of a system for enhancing hearing in a selected range of frequencies, constructed and operative in accordance with a further embodiment of the disclosed technique;

FIG. 7 is a schematic illustration of a system for enhancing hearing in a selected range of frequencies, constructed and operative in accordance with another embodiment of the disclosed technique;

FIG. 8, which is a schematic illustration of a method for operating the system of FIG. 1, operative in accordance with a further embodiment of the disclosed technique;

FIG. 9 is a schematic illustration of a system for producing a modified signal, constructed and operative in accordance with another embodiment of the disclosed technique;

FIG. 10 is a schematic illustration of a system for producing a modulated signal, constructed and operative in accordance with a further embodiment of the disclosed technique; and

FIG. 11 is a schematic illustration of a method for enhancing hearing in a selected range of frequencies, operative in accordance with another embodiment of the disclosed technique.

### DETAILED DESCRIPTION OF THE EMBODIMENTS

The disclosed technique overcomes the disadvantages of the prior art by providing a system which enhances hearing in a desired range of frequencies of an ambient sound, by producing sounds having the characteristics of the otoacoustic emissions (OAE), at this desired range of frequencies. Since the OAE sound is at the same frequency range as that of the desired range of frequencies of the ambient sound, the portion of the ambient sound at the desired range of frequencies resonates and the acoustic energy thereof increases. Thus, the listener can hear better at the desired range of frequencies, while the ambient sound is not actually amplified at the desired range of frequencies.

The term “otoacoustic emissions” (OAE) herein below, refers to traveling waves produced in the fluid of the cochlea, by the mechanical vibrations of at least a portion of the outer hair cells. The term “ear” herein below, refers to an ear of a human being as well as that of an animal. The term “animal” includes warm-blooded vertebrates, cold-blooded vertebrates, invertebrates, avians, reptiles, aquatic animals, amphibians, and the like.

The term “electro-acoustic transducer” herein below, refers to a device (e.g., a loudspeaker, an earphone) which converts electrical signals to acoustical signals (i.e., sound). An electro-acoustic transducer can operate based on principles of electrodynamics, magnetism, piezoelectricity, magnetostriction, hydraulic, and the like.

An acousto-electric transducer is a device (e.g., a microphone) which converts sound (i.e., acoustic signals) to electric signals. An acousto-electric transducer can operate based on principles of electrodynamics, electrostatics, piezoelectricity, magnetostriction, fiber-optics, stimulation of carbon particles, and the like. It is noted that an acousto-electric transducer can be replaced by an inductor (i.e., a coil), which produces an electric signal in response to an electromagnetic signal (i.e., the electromagnetic signal can be produced for example, by another loudspeaker, such as that of a telephone handset). Accordingly, for the purpose of the following description, the term acousto-electric transducer shall also refer to transducers which are directed at detecting non-acoustic signals (e.g., electromagnetic) which represent acoustic disturbances.

The term “critical band” herein below, refers to that band [F₁,F₂] of a band-pass noise (i.e., a masker) sounded together with a sinusoidal (F₁<f<F₂) sound (i.e., a masker) to an ear, beyond which the listener does not report improvement in detecting the sinusoidal sound. The critical band can be determined statistically by performing an audio experiment among a substantially large number of subjects.

The ear is divided to a plurality of auditory filters. Each auditory filter is defined by a band, exhibiting a center frequency and a bandwidth. The bandwidth of the auditory filters increase with their center frequency. The bands of the auditory filters are partially overlapping, at the edges thereof. It is proposed that the auditory filter bank of man consists of twenty four filters (i.e., the audible range can be divided to twenty four critical bands). See E. Zwicker, G. Flottorp and S. S. Stevens (1957) “Critical bandwidth in loudness summation” J. Acoust. Soc. Am. 29: 548-557. The value of each critical band among the normally hearing subjects of the same species is substantially the same. The twenty four critical bands are shown in Table 1.

TABLE 1

| | Center | |
|---|---|---|
| No. | frequency | Bandwidth |
| 1 | 50 | 80 |
| 2 | 150 | 100 |
| 3 | 250 | 100 |
| 4 | 350 | 100 |
| 5 | 450 | 110 |
| 6 | 570 | 120 |
| 7 | 700 | 140 |
| 8 | 840 | 150 |
| 9 | 1000 | 160 |
| 10 | 1170 | 190 |
| 11 | 1370 | 210 |
| 12 | 1600 | 240 |
| 13 | 1850 | 280 |
| 14 | 2150 | 320 |
| 15 | 2500 | 380 |
| 16 | 2900 | 450 |
| 17 | 3400 | 550 |
| 18 | 4000 | 700 |
| 19 | 4800 | 900 |
| 20 | 5800 | 1100 |
| 21 | 7000 | 1300 |
| 22 | 8500 | 1800 |
| 23 | 10500 | 2500 |
| 24 | 13500 | 3500 |

A waveform storage unit or a database herein below, is a data storage unit, such as magnetic memory unit (e.g., floppy diskette, hard disk, magnetic tape), optical memory unit (e.g., compact disk), volatile electronic memory unit (e.g., random access memory), non-volatile electronic memory unit (e.g., read only memory, flash memory), and the like.

The term “dynamic range” herein below, refers to the ratio of the high volume sounds and the low volume sounds. The dynamic range in a normally hearing ear is approximately between 80-100 decibels (dB), while in a hearing impaired ear it is between 15-30 dB. A normally hearing ear controls the dynamic range by changing the activation threshold of the inner hair cells and by changing the OAE generated by the outer hair cells.

The term “sensational level” herein below, refers to the level of a sound in decibels above the audibility threshold of an individual listener. This audibility threshold is known in the art as speech recognition threshold (SRT). The sensational level (SL) in man is approximately 20 dB above the SRT. The sensational level for normal speech is approximately 30 dB SL, and for a whispering sound it is approximately 5 dB SL. A sensational level of 40 dB and above is usually distracting to the listener. In the following disclosure, the terms “volume” and “amplitude” are used interchangeably and are associated with sound.

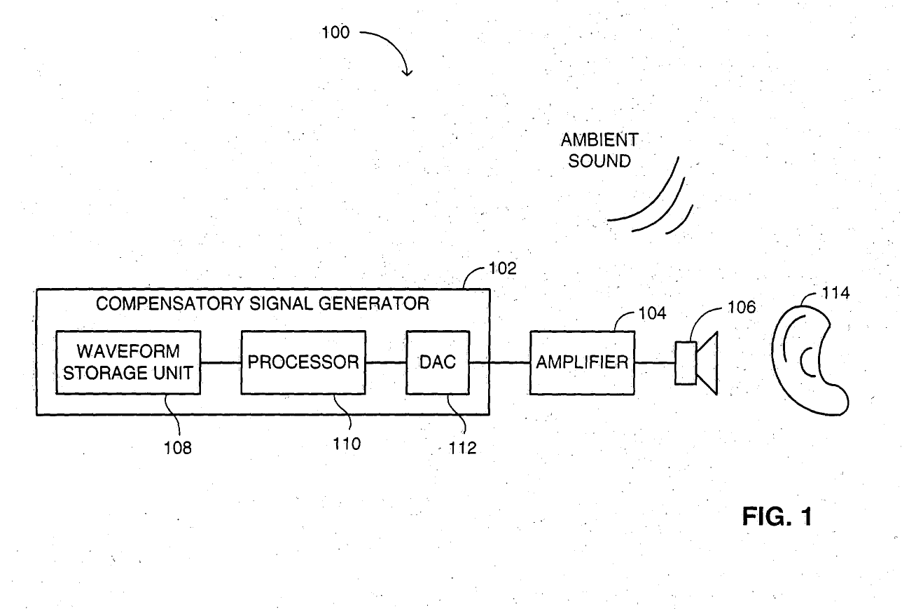

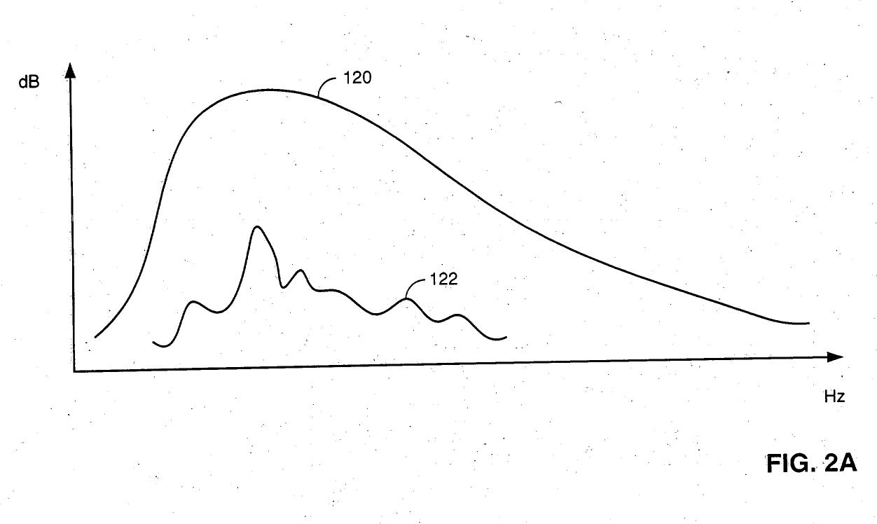

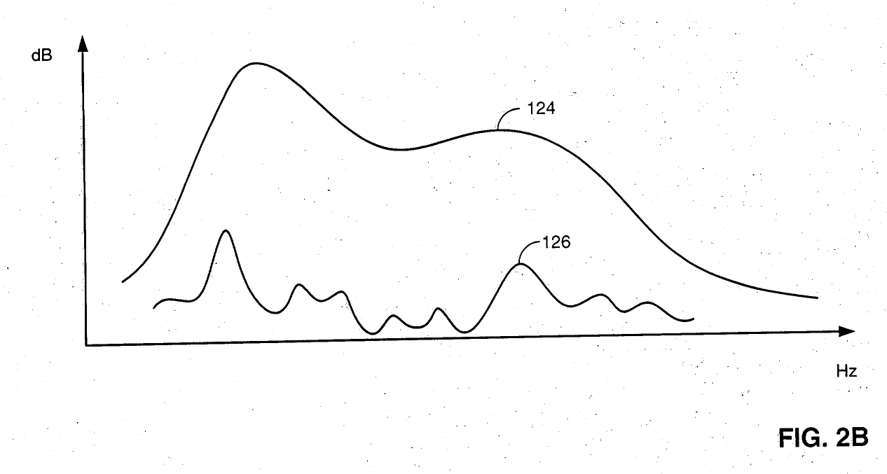

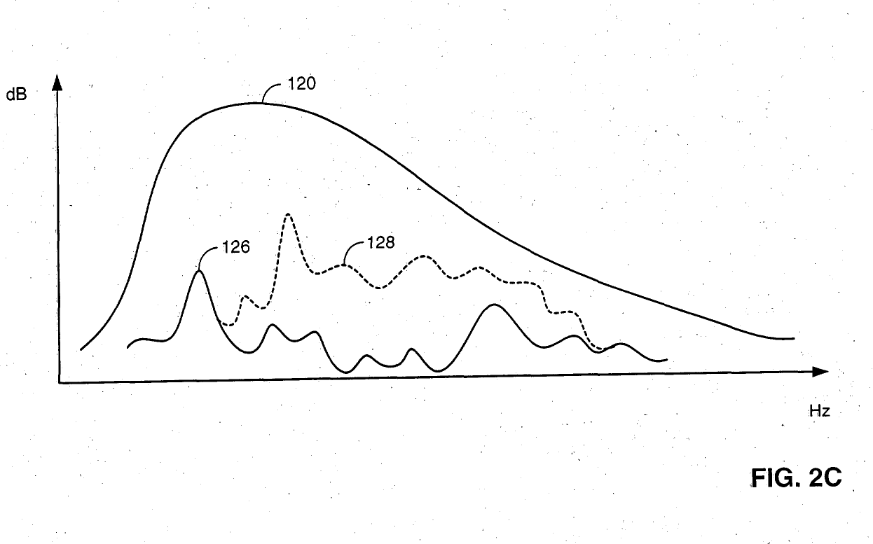

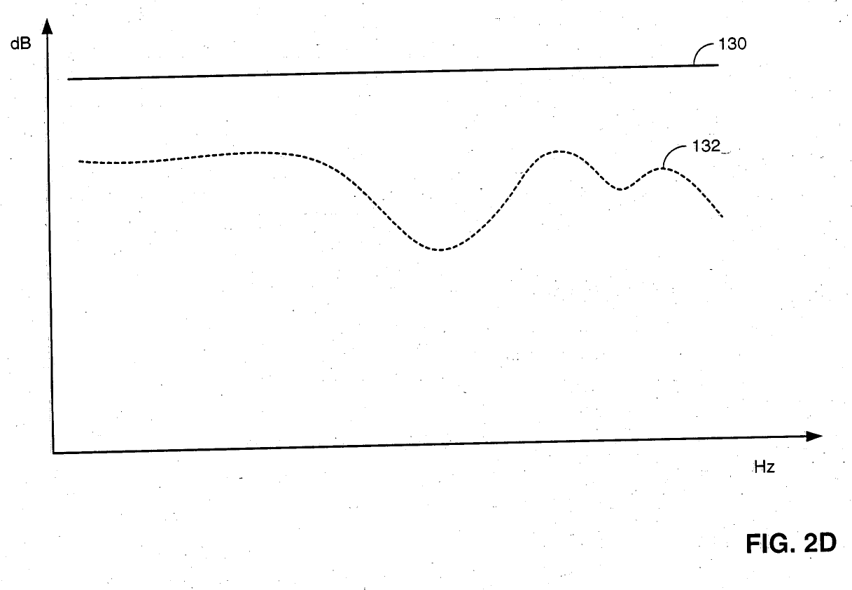

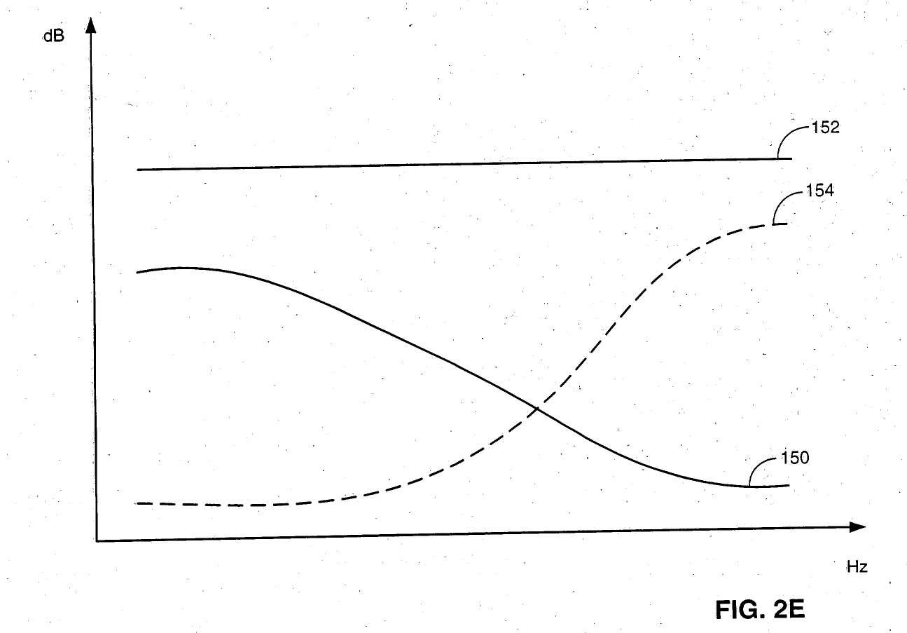

Reference is now made to FIGS. 1, 2A, 2B, 2C, 2D and 2E. FIG. 1 is a schematic illustration of a system for enhancing hearing in a selected range of frequencies, generally referenced 100, constructed and operative in accordance with an embodiment of the disclosed technique. FIG. 2A is a schematic graph of a normal hearing spectrum of a normally hearing ear and a normal OAE Waveform of the normally hearing ear. FIG. 2B is a schematic graph of an abnormal-hearing spectrum of a hearing impaired ear and an abnormal-OAE waveform of the hearing impaired ear. FIG. 2C is a schematic graph of the abnormal-OAE waveform of FIG. 2B and a compensatory OAE waveform, which when added together, result in the normal hearing spectrum of FIG. 2A. FIG. 2D is a schematic graph of a plurality of waveforms illustrating a case to bring about uniform response of an ear in substantially the entire audible range of frequencies. FIG. 2E is a schematic graph of a plurality of waveforms illustrating a case to improve hearing in a selected range of frequencies.

System 100 includes a compensatory signal generator 102, an amplifier 104 and an electro-acoustic transducer 106. Compensatory signal generator 102 includes a waveform storage unit 108, a processor 110 and a digital to analog converter (DAC) 112. System 100 includes a power supply (not shown) to supply electric power to compensatory signal generator 102, amplifier 104 and to electro-acoustic transducer 106.

Processor 110 is coupled with waveform storage unit 108 and with DAC 112. Amplifier 104 is coupled with DAC 112 and with electro-acoustic transducer 106.

System 100 is a remote sound system which is located external to abnormal ear 114 (i.e., a hearing impaired ear), such that abnormal ear 114 is responsive to both the ambient sound and the sound produced by electro-acoustic transducer 106. A compensatory signal generator similar to compensatory signal generator 102 can be either an analog unit, a digital unit, or a mixture of analog and digital.

The waveform of a sound which is to be produced by an electro-acoustic transducer 106, is stored in waveform storage unit 108. This waveform can be either in an analog format (e.g., sound on a magnetic tape) or a digital format (e.g., WAV, MPEG). The waveform which is stored in waveform storage unit 108 can be made according to the detected OAE of the ear for which system 100 is constructed. Alternatively, the waveform which is stored in waveform storage unit 108 can be made according to the detected OAE of an ear other than the one for which system 100 is constructed (e.g., a representative ear).

Alternatively, the waveform which is stored in waveform storage unit 108 can be made according to a desired hearing spectrum (e.g., to enable an ear to hear sounds better at a specific range of frequencies, or reduce the sensitivity of an ear to sounds at a specific range of frequencies). In this case, information respective of the audiogram (i.e., hearing spectrum) of the ear for which system 100 is constructed, is employed to construct the waveform which is stored in waveform storage unit 108.

With reference to FIG. 2A, curve 120 represents a normal hearing spectrum of a normal ear. Curve 122 represents the normal OAE waveform of the normal ear in the absence of system 100 (i.e., the OAE which the outer hair cells of the normal ear normally produce). Curve 122 can represent any type of typically detected otoacuostic emissions, such as spontaneous otoacoustic emissions (SOAE), distortion product otoacoustic emissions (DPOAE), transient-evoked otoacoustic emissions (TEOAE), and the like.

With reference to FIG. 2B, curve 124 represents an abnormal-hearing spectrum of abnormal ear 114. Curve 126 represents the abnormal-OAE waveform of abnormal ear 114 in the absence of system 100 (i.e., the OAE which the outer hair cells of abnormal ear 114 normally produce). With reference to FIG. 2C, curve 128 represents a compensatory OAE waveform.

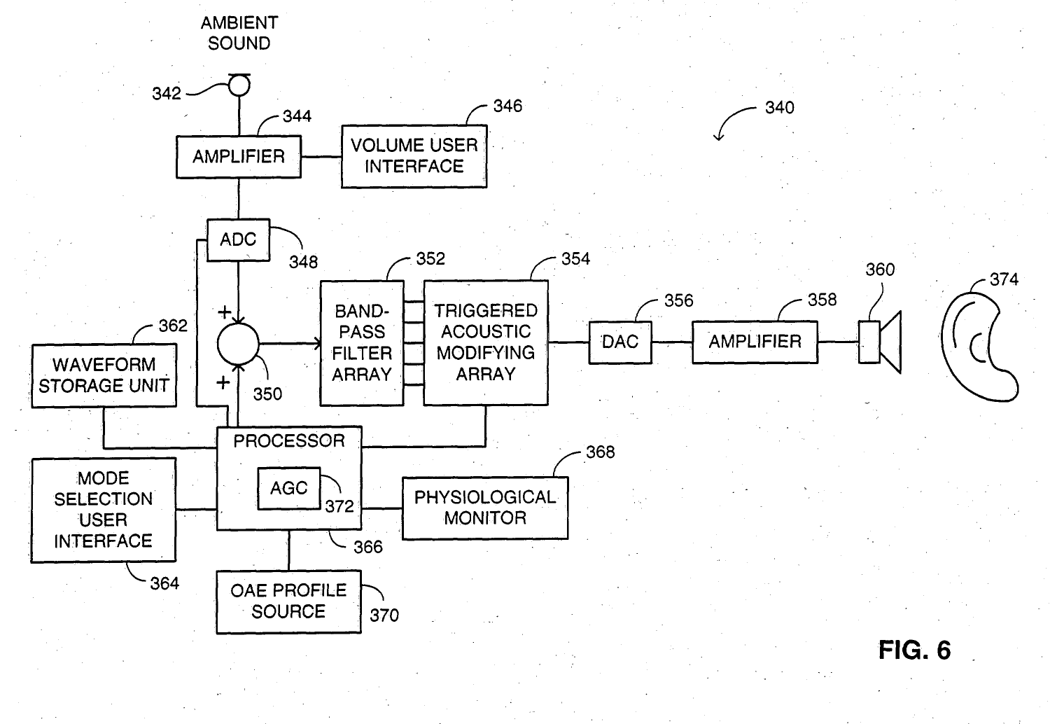

Processor 110 determines compensatory OAE waveform 128 according to abnormal-OAE waveform 126 and processor 110 stores compensatory OAE waveform 128 in waveform storage unit 108. Alternatively, compensatory OAE waveform 128 is stored in waveform storage unit 108 from an external source (not shown), such as OAE profile source 370 (FIG. 6), which is described herein below. Processor 110 retrieves compensatory OAE waveform 128 from waveform storage unit 108. Processor 110 repeatedly produces a compensatory signal according to compensatory OAE waveform 128 and processor 110 provides the compensatory signal to DAC 112. Processor 110 determines the overall volume of the compensatory signal and produces the compensatory signal according to the determined volume. DAC 112 produces an analog compensatory signal by converting the compensatory signal from digital format to analog format and provides the analog compensatory signal to amplifier 104. Amplifier 104 produces an amplified compensatory signal by amplifying the analog compensatory signal and provides the amplified-compensatory signal to electro-acoustic transducer 106. Electro-acoustic transducer 106 produces a compensatory sound in the vicinity of abnormal ear 114, according to the amplified compensatory signal. Abnormal ear 114 hears a combination of the compensatory sound and the ambient sound.

The compensatory sound produced by electro-acoustic transducer 106 has a waveform similar to that of curve 128. The compensatory sound corresponding to compensatory OAE waveform 128, is a sound which when produced for abnormal ear 114, compensates for the hearing impairment of abnormal ear 114. The compensatory sound together with the abnormal-OAE sounds of the outer hair cells of abnormal ear 114 represented by curve 126, have the same effect that the outer hair cells of abnormal ear 114 would produce normal OAE sounds. Thus, system 100 enables abnormal ear 114 to hear the ambient sound like a normal ear, the normal ear having a normal hearing spectrum represented by curve 120 (FIG. 2C).

The sounds produced by electro-acoustic transducer 106 according to compensatory OAE waveform 128, produce traveling waves in the fluid of the cochlea of the normal ear, which have the same effect as those which could have been produced by the outer hair cells (not shown) of the normal ear, according to signals transmitted by the brain stem. These traveling waves amplify the response and the firing rate of a portion of auditory neurons stimulated by the inner hair cells (not shown), at frequencies specific for this portion of auditory neurons and thus, abnormal ear 114 is made more responsive to the ambient sound at these specific frequencies.

With reference to FIG. 2D, line 130 represents a desirable hearing spectrum of abnormal ear 114 (i.e., system 100 is to be constructed such that the sensitivity of abnormal ear 114 to sounds, is substantially the same across the entire audible frequency range of the normal ear). Curve 132 represents a modified compensatory OAE waveform. Processor 110 determines modified compensatory OAE waveform 132, by modifying compensatory OAE waveform 128, such that the hearing spectrum of abnormal ear 114 will be similar to line 130. When system 100 produces a compensatory sound according to modified compensatory OAE waveform 132, the hearing spectrum of the abnormal ear 114 is modified from that of curve 120 (FIG. 2C), to that of line 130. It is noted that likewise, with the aid of an appropriate compensatory signal, the hearing spectrum of a normal ear can be modified from that of curve 120 to that of line 130. It is further noted that system 100 can operate also without employing amplifier 104, in which case electro-acoustic transducer 106 produces sounds according to an analog signal received from DAC 112.

With reference to FIG. 2E, curve 150 represents the abnormal-hearing spectrum of abnormal ear 114. Abnormal-hearing spectrum 150 is representative of the ear of a hearing impaired person, who can hear sounds at low frequencies, but is unable to hear sounds at high frequencies. Curve 152 represents a desired hearing spectrum for abnormal ear 114. Curve 154 represents a modified compensatory OAE waveform. The amplitude of modified compensatory OAE waveform 154 is low at low frequencies (i.e., at those frequencies which abnormal ear 114 is more sensitive) and high at high frequencies (i.e., at those frequencies which abnormal ear 114 is less sensitive).

When system 100 produces sounds' in the vicinity of abnormal ear 114, the hearing spectrum of abnormal ear 114 changes form abnormal-hearing spectrum 150 to desired hearing spectrum 152 (i.e., abnormal ear 114 is equally sensitive at substantially the entire audible frequency range). The compensatory OAE sound produced by electro-acoustic transducer 106 according to modified compensatory OAE waveform 152, compensates for the inefficiency of abnormal ear 114. This compensatory OAE sound corrects abnormal-hearing spectrum 150 to desired hearing spectrum 152.

It is noted that a system similar to system 100 can be employed to, prevent the normal ear to hear at a selected frequency range, by canceling the effect of the outer hair cells in this selected range. In this case the system produces an OAE sound which is anti-phase to the OAE which the outer hair cells of the normal ear produce, in the selected frequency range (i.e., the OAE sounds produced by system 100 is out of phase by substantially 180 degrees relative to the ear OAE). Thus, the OAE sound produced by system 100 cancels the OAE sound produced by the normal ear in the selected frequency range and the normal ear will hear almost no ambient sound in the selected frequency range. It is further noted that in case the full spectrum of a compensatory OAE waveform would interfere either with a normal OAE waveform (e.g., curve 122), or with an abnormal-OAE waveform (e.g., curve 126), compensatory signal generator 102 can produce only a portion of the compensatory OAE waveform in terms of frequency, amplitude, and the like.

According to another aspect of the disclosed technique, an ambient sound signal produced by detecting an ambient sound, is mixed with a compensatory signal, wherein the compensatory signal has certain characteristics which are selected to enhance hearing of at least a portion of the ambient sound. A mixed ambient sound is produced in the vicinity of an ear, according to the mixture of the ambient sound signal and the compensatory signal.

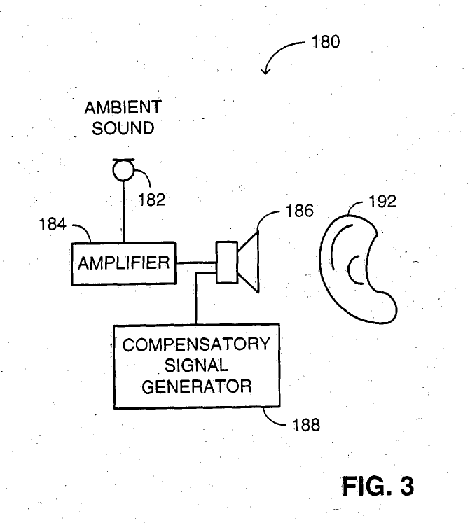

Reference is now made to FIG. 3, which is a schematic illustration of a system for enhancing hearing in a selected range of frequencies, generally referenced 180, constructed and operative in accordance with another embodiment of the disclosed technique. System 180 includes an acousto-electric transducer 182, an amplifier 184, an electro-acoustic transducer 186 and a compensatory signal generator 188. Compensatory signal generator 188 is similar to compensatory signal generator 102 (FIG. 1) as described herein above.

Acousto-electric transducer 182 is coupled with amplifier 184. Compensatory signal generator 188 is coupled with electro-acoustic transducer 186. Electro-acoustic transducer 186 is coupled with amplifier 184 and with compensatory signal generator 188.

System 180 can be a device which induces sounds to the ear and as such, it can be placed within an ear 192 (e.g., within an ear canal which is not shown), behind ear 192, or over ear 192 (e.g., a headphone). In case of a within-the-ear device, acousto-electric transducer 182, amplifier 184, electro-acoustic transducer 186 and compensatory signal generator 188 are located in a housing (not shown), within the ear canal and electro-acoustic transducer 186 stimulates a tympanic membrane (not shown) of ear 192. In case of a behind-the-ear device, acousto-electric transducer 182, amplifier 184, electro-acoustic transducer 186 and compensatory signal generator 188 are placed behind ear 192 and the sound produced by electro-acoustic transducer 186 is conveyed to the tympanic membrane, via a sound conveyer (e.g., a tubing).

Acousto-electric transducer 182 detects an ambient sound, produces an ambient sound signal respective of the detected ambient sound and provides the ambient sound signal to amplifier 184. Amplifier 184 produces an amplified ambient sound signal, by amplifying the ambient sound signal. Compensatory signal generator 188 produces a compensatory signal according to a waveform stored in a waveform storage unit similar to waveform storage unit 108 (FIG. 1). This compensatory signal can have a waveform such as that of curve 128 of FIG. 2C (i.e., a compensatory OAE waveform).

Electro-acoustic transducer 186 produces a combined ambient sound for ear 192, according to the ambient sound signal and the compensatory signal. Since the combined ambient sound includes OAE sounds at a specific range (or ranges) of frequencies, the inner hair cells (not shown) of ear 192 respective of these specific ranges (which normally are not sufficiently stimulated), are now stimulated. Thus, ear 192 is more sensitive and responsive to sounds at these ranges of frequencies.

According to a further aspect of the disclosed technique, a mixture of an ambient sound signal and a compensatory signal is filtered to a plurality of selected bands, wherein each band corresponds with a predetermined critical band of an ear. The resonance in each selected band of the ambient sound signal, which is caused by the compensatory signal, raises the amplitude of the ambient sound signal in the respective band. The ambient sound signal is modified according to the compensatory signal, when the energy of the ambient sound signal is substantially equal to or greater than a threshold. A sound is produced according to the modified ambient sound signal. The volume of the sound in the selected bands is higher than those of the ambient sound, thereby enhancing the hearing in the selected bands.

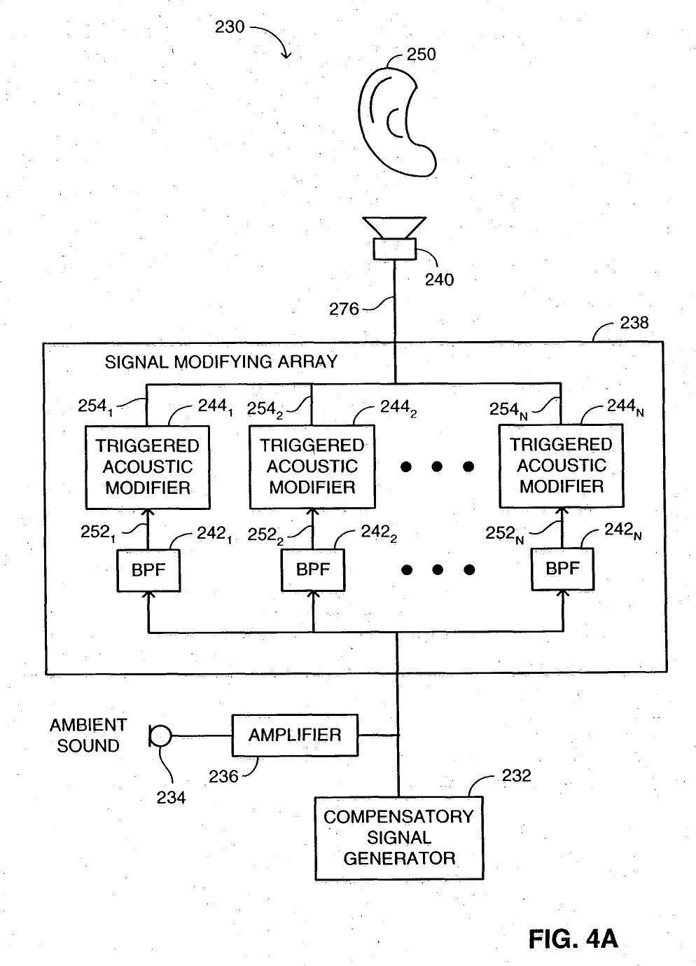

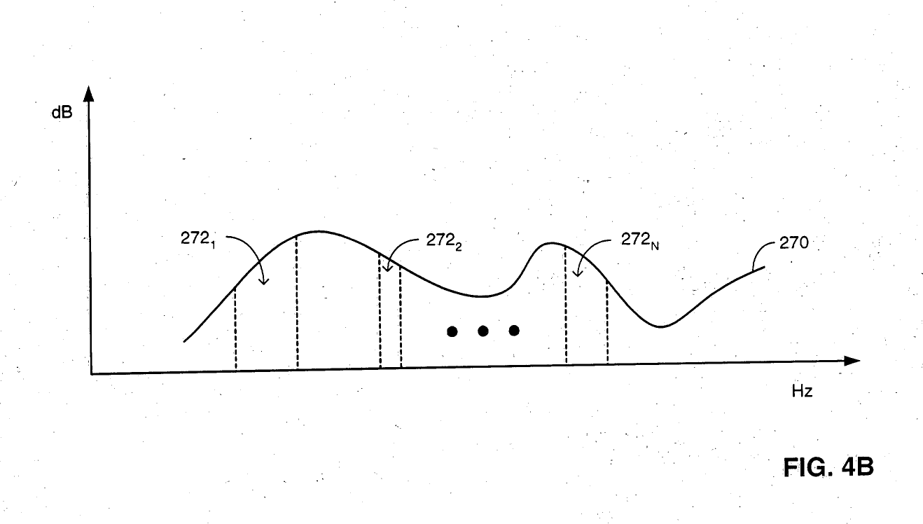

Reference is now made to FIGS. 4A and 4B. FIG. 4A is a schematic illustration of a system for enhancing hearing in a selected range of frequencies, generally referenced 230, constructed and operative in accordance with a further embodiment of the disclosed technique. FIG. 4B is a schematic graph of a combined signal, generally referenced 270, which is a combination of a compensatory signal produced by a compensatory signal generator of the system of FIG. 4A and an ambient sound signal.

System 230 includes a compensatory signal generator 232, an acousto-electric transducer 234, an amplifier 236, a signal modifying array 238 and an electro-acoustic transducer 240. Signal modifying array 238 includes a plurality of band-pass filters (BPF) 242₁, 242₂ and 242_{N} and a plurality of triggered acoustic modifiers 244₁, 244₂ and 244_{N}. System 230 also includes a power supply (not shown) to supply electric power to compensatory signal generator 232, acousto-electric transducer 234, amplifier 236, signal modifying array 238 and electro-acoustic transducer 240.

Compensatory signal generator 232 is similar to compensatory signal generator 102 (FIG. 1) as described herein above. Each of band-pass filters 242₁, 242₂ and 242_{N} is an electronic filter which receives an input signal at a plurality of frequencies and outputs a selected frequency band of the input signal. The quantity of band-pass filters 242₁, 242₂ and 242_{N} is preferably equal to twenty four (i.e., the number of auditory filters in the ear of man), however system 230 can include any number of band-pass filters 242₁, 242₂ and 242_{N}. In any case, the quantity of band-pass filters 242₁, 242₂ and 242_{N} and triggered acoustic modifiers 244₁, 244₂ and 244_{N} is the same. Each of band-pass filters 242₁, 242₂ and 242_{N} corresponds to a different one of the twenty four bands, as depicted in Table 1 herein above.

Each of triggered acoustic modifiers 244₁, 244₂ and 244_{N} is a device which receives an input signal and outputs a modified form of the input signal, when the energy (i.e., the integral over time of the input signal in a selected time interval), is substantially equal to or greater than a threshold. Thus, each of triggered acoustic modifiers 244₁, 244₂ and 244_{N} outputs the modified form of the input signal, when triggered.

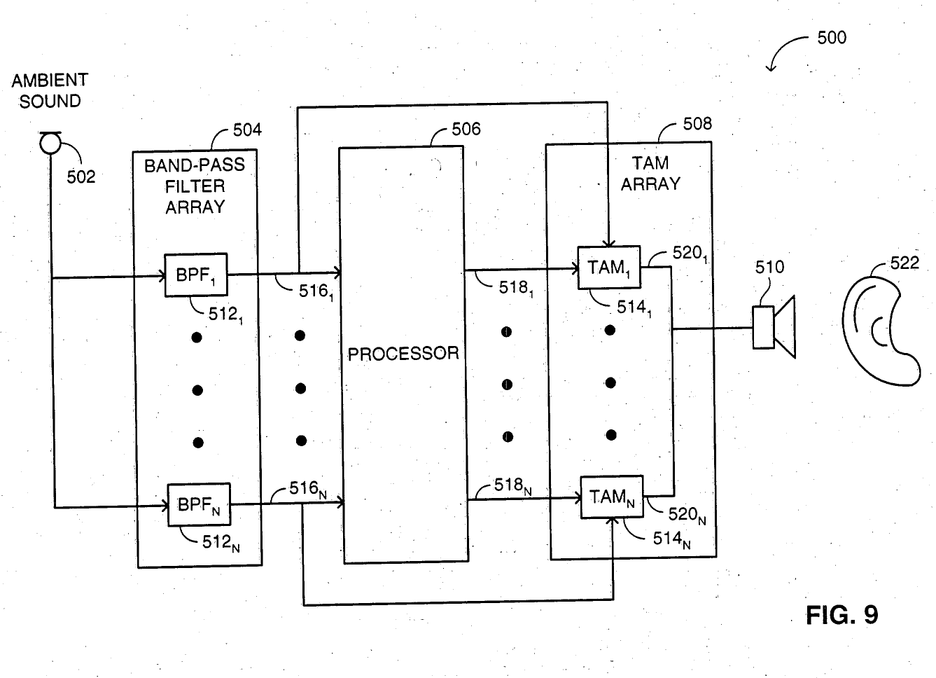

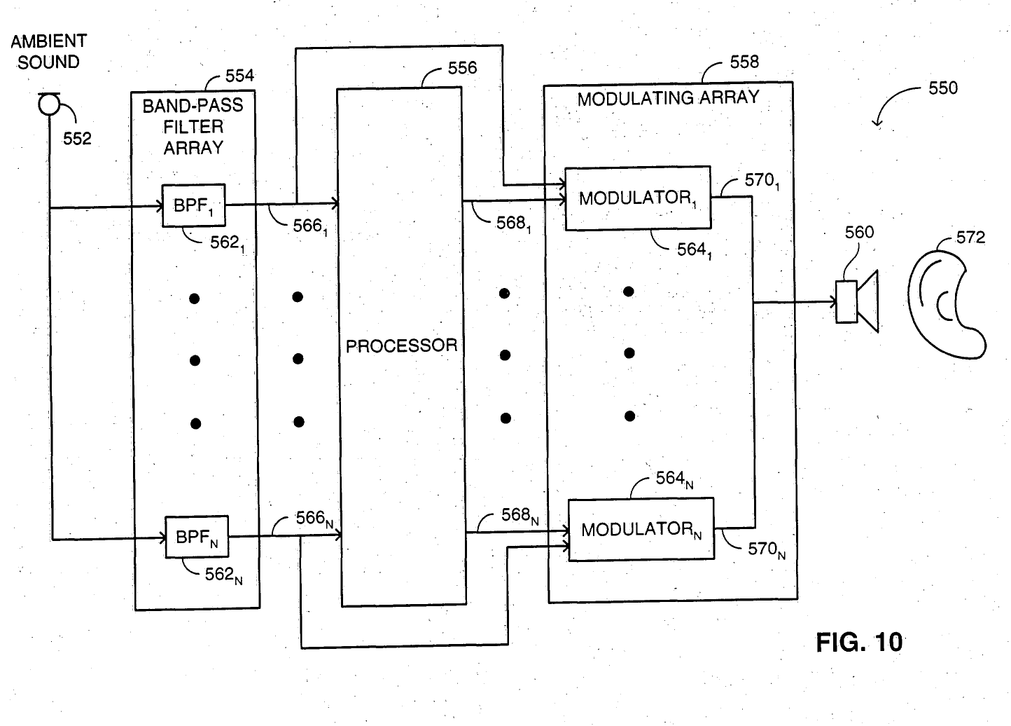

The threshold of each of triggered acoustic modifiers 244₁, 244₂ and 244_{N} can be either set at a predetermined value, or dynamically changed during the operation of system 230. The threshold of triggered acoustic modifiers 244₁, 244₂ and 244_{N} can be either substantially equal or different. Each of triggered acoustic modifiers 244₁, 244₂ and 244_{N} modifies the input signal in different ways, such as by modulating the input signal with a carrier signal (e.g., a compensatory signal), mixing the input with a carrier signal (e.g., a compensatory signal), and the like. Different types of triggered acoustic modifiers 244₁, 244₂ and 244_{N} are described herein below in connection with FIGS. 9 and 10.

Amplifier 236 is coupled with acousto-electric transducer 234, compensatory signal generator 232 and with band-pass filters 242₁, 242₂ and 242_{N}. Band-pass filters 242₁, 242₂ and 242_{N} are coupled with triggered acoustic modifiers 244₁, 244₂ and 244_{N}, respectively. Electro-acoustic transducer 240 is coupled with triggered acoustic modifiers 244₁, 244₂ and 244_{N}. Electro-acoustic transducer 240 is located in the vicinity of an ear 250 (e.g., within an ear canal of ear 250, or substantially adjacent to the ear canal, such as a loudspeaker of a headphone).

With reference back to FIG. 2C, compensatory signal generator 232 produces a compensatory signal similar to curve 128. The compensatory signal can be produced according to the frequencies within an OAE waveform (i.e., those frequencies at which the outer hair cells of an ear usually vibrate). Alternatively, the compensatory signal can be produced according to frequencies slightly below or above those of an OAE waveform (i.e., those frequencies slightly below or above the ones at which the outer hair cells of an ear usually vibrate, and at least some of the frequencies at which the outer hair cells of the ear usually vibrate).

Acousto-electric transducer 234 detects an ambient sound, produces an ambient sound signal according to the detected ambient sound and provides the ambient sound signal to amplifier 236. Amplifier 236 produces an amplified ambient sound signal by amplifying the ambient sound signal. Each of band-pass filters 242₁, 242₂ and 242_{N} receives a combined ambient signal (i.e., a combination of the amplified ambient sound signal and the compensatory signal) and produces a filtered signal in a predetermined band. Band-pass filters 242₁, 242₂ and 242_{N} filter combined signal 270 and produce filtered signals 252₁, 252₂ and 252_{N}, respectively. Filtered signals 252₁, 252₂ and 252_{N} correspond to bands 272₁, 272₂ and 272_{N}, respectively. Each of bands 272₁, 272₂ and 272_{N} corresponds to a different critical band of ear 250.

Triggered acoustic modifiers 244₁, 244₂ and 244_{N} receive filtered signals 252₁, 252₂ and 252_{N}, respectively, and produce modified signals 254₁, 254₂ and 254_{N}, respectively, when the energy of filtered signals 252₁, 252₂ and 252_{N}, respectively, is substantially equal to or greater than a threshold which is set for the respective one of triggered acoustic modifiers 244₁, 244₂ and 244_{N}. Triggered acoustic modifiers 244₁, 244₂ and 244_{N} produce modified signals 254₁, 254₂ and 254_{N}, respectively, by modifying filtered signals 252₁, 252₂ and 252_{N} respectively, for example by modulating filtered signals 252₁, 252₂ and 252_{N} with the ambient sound signal or mixing them with the ambient sound signal. The amplitude of modified signals 254₁, 254₂ and 254_{N} is preferably greater than the threshold of triggered acoustic modifiers 244₁, 244₂ and 244_{N}, respectively (e.g., by 5-10 dB). The amplitude of the compensatory signal is preferably less than the threshold which is set for triggered acoustic modifiers 244₁, 244₂ and 244_{N}.

Modified signals 254₁, 254₂ and 254_{N} combine to produce a combined modified signal 276. Electro-acoustic transducer 240 produces a combined modified sound for ear 250, according to combined modified signal 276.

Signal modifying array 238 operates according to stochastic resonance theory (see for example, Bruce McNamara and Kurt Wiesenfeld, “Theory of Stochastic Resonance”, The American Physical Society, Physical Review A, May 1, 1989, Volume 39, Number 9). The theory considers a bistable double well potential subject to no noise and no periodic forcing. A heavily damped particle will come to rest at one of the two minima of the potential. When the potential of the particle exceeds a barrier Uₒ located in the center of the two minima, the particle moves from one well to the other. The particle jumps from one well to other and back, at rates W+ and W−. The characteristic rate associated with the bistable system is given by,

α=W₊+W₋ (1)

In the presence of a moderate amount of random forcing (i.e., noise), the particle will spend most of its time at each of the two wells, but occasionally the potential of the particle rises enough to exceed Uₒ, thereby allowing the particle to make occasional transitions over the barrier. As the input noise variance, D, is increased, the rate at which such jumps will occur, W+ and W−, increases. As D is increased, both W+ and W− increase and therefore α increases. If the frequency of the noise is denoted ω, the signal output power and thus the signal-to-noise ratio (SNR) reaches a maximum level when,

α≈ω (2)

however, the frequency of the output signal will be distorted and different than the input signal, thereby indicating the non-linear nature of stochastic resonance. This frequency distortion is compatible with the fact that the outer hair cells of the ear vibrate at a different frequency compared with that of the inner hair cells, wherein the resultant frequency (i.e., the frequency which is detected by the auditory neurons, as a result of the effect of the outer hair cells on the inner hair cells), is different than the frequency of the sound at the oval window of the cochlea.

In terms of the disclosed technique, the ambient sound signal is substantially equivalent to the bistable system of the heavily damped particle, the compensatory signal is substantially equivalent to the random forcing (i.e., the noise), the frequency of the ambient sound signal is substantially equivalent to α, and the frequency of the compensatory signal is substantially equivalent to ω. Thus, when the frequency of the compensatory signal is substantially equal to the frequency of the ambient sound signal, due to stochastic resonance, the SNR of the ambient sound signal at this frequency reaches a maximal. However, due to the non-linear nature of stochastic resonance, the resultant ambient sound signal frequency is different than the original ambient sound signal frequency, and thus distorted.

The frequency of modified signals 254₁, 254₂ and 254_{N} is different than that of filtered signals 252₁, 252₂ and 252_{N}, respectively (i.e., filtered signals 252₁, 252₂ and 252_{N} are distorted), and the SNR of modified signals 254₁, 254₂ and 254_{N} is substantially greater than that of filtered signals 252₁, 252₂ and 252_{N}, respectively. Thus, the necessary conditions for stochastic resonance are satisfied (i.e., stochastic resonance of the ambient sound signal at bands 272₁, 272₂ and 272_{N}, takes place at triggered acoustic modifiers 244₁, 244₂ and 244_{N}, respectively). Therefore, ear 250 is capable to detect the ambient sound better at bands 272₁, 272₂ and 272_{N} of the ambient sound.

When ear 250 is stimulated by a desirable sound produced by a, sound source (not shown), located substantially close to ear 250, wherein the desirable sound is in the same frequency range as that of the background sound, ear 250 can hardly discriminate the desirable sound from the background sound. System 230 improves the ability of ear 250 to discriminate the desirable sound from the background sound.

For example, if ear 250 is exposed to the speech sound of a talking person who is talking directly toward ear 250, against a background sound of other talking people, ear 250 hears the sound of the talking person at a volume slightly higher than the background sound. However, due to the fact that the sound of the talking person and the background sound, are at substantially the same frequency range (e.g., 1000 Hz), ear 250 can hardly discriminate the speech of the talking person from the background sound.

Compensatory signal generator 232 produces a compensatory signal. Acousto-electric transducer 234 detects the sound of the talking person and produces an ambient sound signal according to the detected ambient sound. One of band-pass filters 242₁, 242₂ and 242_{N} Which corresponds to the frequency of the sound whose amplitude is slightly higher than the background sound (in this case 1000 Hz), for example band-pass filter 242₂, produces a filtered signal by filtering the combined ambient sound (i.e., a combination of the ambient sound signal and the compensatory signal). Band-pass filter 242₂ provides the filtered signal to triggered acoustic modifier 244₂. Triggered acoustic modifier 244₂ produces a modified signal according to the filtered signal, when the energy of the filtered signal is greater than a threshold.

Due to stochastic resonance in the filtered signal, the amplitude of those portions of the ambient sound signal which were originally at a slightly higher amplitude (i.e., the signals corresponding to the sound of the talking person), are considerably amplified in the modified signal, due to the operation of triggered acoustic modifier 244₂. Electro-acoustic transducer 240 produces a modified sound according to the modified signal in the vicinity of ear 250. Since the volume of that portion of the modified sound corresponding to the talking person is higher than that of the background sound, ear 250 can more easily discriminate the sound of the talking person from the background sound.

It is noted that due to the inherent property of stochastic resonance, those portions of the ambient sound signal whose amplitude were originally higher than the rest, are distorted the least (i.e., the frequencies at these portions of the modified sound produced by electro-acoustic transducer 240, are essentially the same as those of the ambient sound). The volume of the desirable sound produced by electro-acoustic transducer 240 is considerably higher than the background sound and the frequency of the desirable sound produced by electro-acoustic transducer 240 is hardly different than the one in the ambient sound. Thus, ear 250 can more easily discriminate the desirable sound from the background sound. According to this aspect of the invention, system 230 can be incorporated with a mobile communication device (e.g., cellular phone), in order to allow the user to discriminate the sounds produced by the mobile communication device from the background sound.

Alternatively, distortion of filtered signals 252₁, 252₂ and 252_{N} or distortion of the compensatory signal is performed by a frequency distorting unit (not shown) separate from triggered acoustic modifiers 244₁, 244₂ and 244_{N}, and not by triggered acoustic modifiers 244₁, 244₂ and 244_{N}.

Further alternatively, the system includes no frequency distorting unit, and the triggered acoustic modifiers distort neither the filtered signals nor the compensatory signal, but the system itself introduces distortions to the signals. In this case, due to inaccurate operation of the elementary electronic components of the system, the elementary electronic components introduce inherent distortions which are similar to the distortions which the triggered acoustic modifiers apply to the filtered signals.

Triggered acoustic modifiers 244₁, 244₂ and 244_{N} produce modified signals 254₁, 254₂ and 254_{N}, respectively, when the energy of filtered signals 252₁, 252₂ and 252_{N}, respectively, is equal to or greater than an upper level threshold. Triggered acoustic modifiers 244₁, 244₂ and 244_{N} cease to produce modified signals 254₁, 254₂ and 254_{N}, respectively, when the energy of filtered signals 252₁, 252₂ and 252_{N}, respectively, is equal to or less than a lower level threshold. The value of the upper level threshold is greater than that of the lower level threshold.

The upper level thresholds of triggered acoustic modifiers 244₁, 244₂ and 244_{N} can be either substantially the same or different. Likewise, the lower level thresholds of triggered acoustic modifiers 244₁, 244₂ and 244_{N} can be either substantially the same or different. In a sense, each of triggered acoustic modifiers 244₁, 244₂ and 244_{N} is similar to a Schmitt trigger.

The processor of compensatory signal generator 232 controls the value of the upper level threshold and the lower level threshold of each of triggered acoustic modifiers 244₁, 244₂ and 244_{N}. An inherent property of triggered acoustic modifiers 244₁, 244₂ and 244_{N} is to compress the dynamic range of filtered signals 252₁, 252₂ and 252_{N}, respectively. Each of triggered acoustic modifiers 244₁, 244₂ and 244_{N} for example, compresses the dynamic range of 100 dB to 20 dB. In a system which is employed for a hearing impaired ear, the upper level threshold and the lower level threshold of each triggered acoustic modifier is set to a constant value, in order to produce the combined modified sound at the desired dynamic range.

In a system which is employed for a normally hearing ear (e.g., to enhance hearing in a selected frequency range, beyond the capability of a normal ear), the compressed dynamic range is undesirable. The processor prevents the triggered acoustic modifiers to compress the dynamic range, by controlling the upper level threshold and the lower level threshold of each triggered acoustic modifier.

In order to mimic a normally hearing ear, the volume of the ambient sound signal and the volume of the compensatory signal, each is preferably slightly less than the upper level threshold of each of the triggered acoustic modifiers (e.g., by 5 dB). In this case, the processor of the compensatory signal generator includes an automatic gain controller (AGC) and the processor is coupled with each of the triggered acoustic modifiers.

The AGC determines the upper level threshold and the lower level threshold of each of the triggered acoustic modifiers and the processor produces a threshold signal for each triggered acoustic modifier, respective of the determined upper level threshold and the lower level threshold. The processor sets the upper level threshold and the lower level threshold of each of the triggered acoustic modifiers, by providing a threshold signal to the respective triggered acoustic modifier.

The processor sets the volume of the compensatory signal and the volume of the ambient sound signal, according to the determined upper level threshold and the lower level threshold. The processor can be coupled for example, with the amplifier, in which case the processor controls the volume of the ambient sound signal, by providing a signal to the amplifier.

The threshold of each of triggered acoustic-modifiers 244₁, 244₂ and 244_{N} and the operating band of each of band-pass filters 242₁, 242₂ and 242_{N} can be set to treat a variety of hearing impairments having different characteristics. For example, if a hearing impaired ear can not detect sounds at frequencies between 1000-2000 Hz, has defective inner hair cells in the 50-100 Hz frequency range (i.e., the detection threshold of the ear in the 50-100 Hz range is high) and the outer hair cells do not produce OAE in the 50-1500 Hz frequency range, then a system similar to system 230 can be constructed.

In the following description, the number preceding the parenthesis, respective of each critical band, refers to the center frequency thereof and the number in the parenthesis refers to the bandwidth thereof. Hence, the 1000-2000 Hz frequency range corresponds with critical band numbers 9, 10, 11, 12 and 13 (Table 1, herein above), whose center frequencies and bandwidths are 1000 Hz (160 Hz), 1170 Hz (190 Hz), 1370 Hz (210 Hz), 1600 Hz (240 Hz) and 1850 Hz (280 Hz), respectively. The 50-100 Hz frequency range corresponds with critical band numbers 1 and 2, whose center frequencies and bandwidths are 50 Hz (80 Hz) and 150 Hz (100 Hz), respectively. The 50-1500 Hz frequency range corresponds with critical band numbers 1, 2, 3, 4, 5, 6, 7, 8, 9, 10 and 11 whose center frequencies and bandwidths are 50 Hz (80 Hz), 150 Hz (100 Hz), 250 Hz (100 Hz), 350 Hz (100 Hz), 450 Hz (110 Hz), 570 Hz (120 Hz), 70Q Hz (140 Hz), 840 Hz (150 Hz), 1000 Hz (160 Hz), 0.1170 Hz (190 Hz) and 1370 Hz (210 Hz), respectively.

In order to overcome the hearing deficiency in the 1000-2000 Hz range, only the ambient sound signal is fed to five band-pass filters similar to band-pass filter 242₁, whose operating bands are set according to critical band numbers 9, 10, 11, 12 and 13. Furthermore, the thresholds of five triggered acoustic modifiers respective of these five band-pass filters are set to approximately zero. In order to overcome the inner hair cells deficiency in the 50-100 Hz range, the ambient sound signal as well as the compensatory signal is fed to two band-pass filters similar to band-pass filter 242₁, whose operating bands are set according to critical band numbers 1 and 2. Furthermore, the thresholds of two triggered acoustic modifiers respective of these two band-pass filters are set to a value lower than the threshold of the ear in the 50-100 Hz range. In order to overcome the outer hair cells deficiency in the 50-1500 Hz range, only the compensatory signal is fed to eleven band-pass filters similar to band-pass filter 242₁, whose operating bands are set according to critical band numbers 1, 2, 3, 4, 5, 6, 7, 8, 9, 10 and 11. Furthermore, the thresholds of eleven triggered acoustic modifiers respective of these eleven band-pass filters are set to approximately zero.

It is noted that according to the disclosed technique, the increase in SNR at bands 272₁, 272₂ and 272_{N} of the ambient sound, is obtained by modifying the ambient sound signal at bands 272₁, 272₂ and 272_{N}, according to the compensatory signal, and not by actually amplifying the ambient sound at bands 272₁, 272₂ and 272_{N}. Thus, system 230 provides substantial savings in terms of energy, thereby reducing the power requirements allowing a substantially smaller and light-weight power source of a given type to be used, or increasing the operating time of the power source.

It is further noted that if the, operating band of each of band-pass filters 242₁, 242₂ and 242_{N} is less than the respective critical band (as depicted in Table 1 herein above), then the operation of system 230 is not optimal. If the operating band of each of band-pass filters 242₁, 242₂ and 242_{N} is more than the respective critical band, then this operating band enters the adjacent critical band and again system 230 does not operate in an optimal manner.

It is further noted that a system similar to system 230 can operate without acousto-electric transducer 234, wherein the ambient sound signal is received from a sound source. The ambient sound signal can be for example, a wired communication system signal (e.g., that produced by a public switched telephone network—PSTN), wireless communication system signal (e.g., that produced by a cellular communication network), broadcast television signal, broadcast radio signal, unicast communication signal (i.e., a signal delivered by a source to a single receiver), multicast communication signal (i.e., a signal delivered by the source to a set of receivers that have been configured as members of a multicast group), anycast communication protocol (i.e., a signal delivered by the source to one member in a group of designated receivers), pre-stored retrieved signal (i.e., a signal retrieved from a database, such as floppy diskette, hard disk, magnetic tape, compact disk, random access memory, read only memory, flash memory, and the like), machine generated signal (e.g., that produced by a synthesizer), and the like. In case of a cellular communication system, a system similar to system 230 can be included in a mobile station in order to improve the hearing for a hearing impaired ear, or enhance the hearing of a normally hearing ear.

Furthermore, this system can be included in a mobile station in order to produce sounds during hand-offs, thereby substantially eliminating the distracting sound gaps which occur when the mobile station is disconnected from one base station and reconnected to another base station. It is further noted that in case some or all of the inner hair cells of ear 250 are defective to such a degree that the hearing threshold of ear 250 is relatively very low, then the triggered acoustic modifiers 244₁, 244₂ and 244_{N} respective of the defective inner hair cells, can be eliminated from system 230.

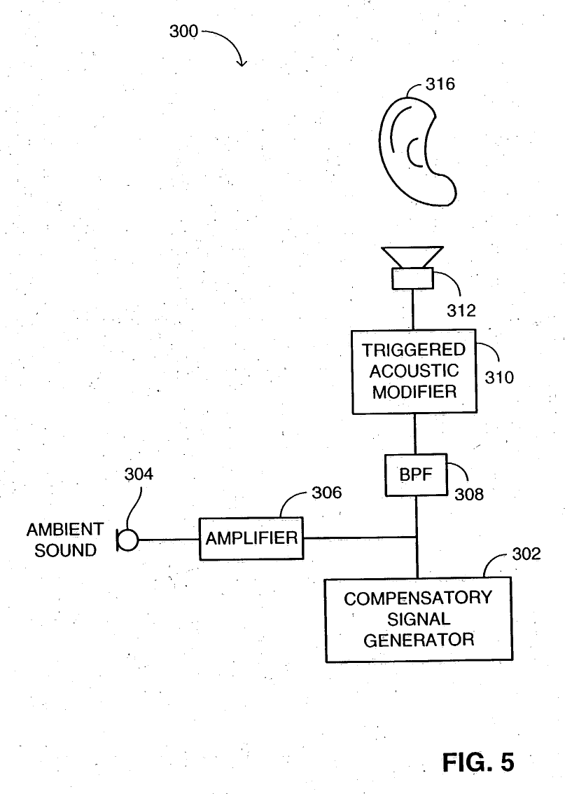

Reference is now made to FIG. 5, which is a schematic illustration of a system for enhancing hearing in a selected range of frequencies, generally referenced 300, constructed and operative in accordance with another embodiment of the disclosed technique. System 300 includes a compensatory signal generator 302, an acousto-electric transducer 304, an amplifier 306, a band-pass filter (BPF) 308, a triggered acoustic modifier 310 and an electro-acoustic transducer 312. Compensatory signal generator 302 is similar to compensatory signal-generator 102 (FIG. 1), as described herein above. Band-pass filter 308 is similar to each of band-pass filters 242₁, 242₂ and 242_{N}, respectively (FIG. 4A), as described herein above. Triggered acoustic modifier 310 is similar to each of triggered acoustic modifiers 244₁, 244₂ and 244_{N}, respectively, as described herein above.

Band-pass filter 308 is coupled with compensatory signal generator 302 and with triggered acoustic modifier 310. Amplifier 306 is coupled with acousto-electric transducer 304, compensatory signal generator 302 and with band-pass filter 308. Electro-acoustic transducer 312 is coupled with triggered acoustic modifier 310.

System 300 operates in a manner similar to system 230, except that only one band-pass filter and only one respective triggered acoustic modifier is employed. Compensatory signal generator 302 produces a compensatory signal at one predetermined band, wherein this predetermined band corresponds with a critical band of an ear 316. Band-pass filter 308 filters the combined ambient sound signal (i.e., a combination of ambient sound signal and the compensatory signal), at this predetermined band. System 300 is a simplified version of system 230, which is employed to enhance hearing in only a selected range of frequencies.

According to another aspect of the disclosed technique, the characteristics of the sound which is produced to enhance the hearing of ambient sound, are dynamically changed according to information obtained from the user. This information includes input from the user to change the volume of the ambient sound, to indicate the type of sounds which are more important to hear, the OAE sounds produced by the ear of the user, and bodily data which indicate the temper of the user.

Reference is now made to FIG. 6, which is a schematic illustration of a system for enhancing hearing in a selected range of frequencies, generally referenced 340, constructed and operative in accordance with a further embodiment of the disclosed technique. System 340 includes an acousto-electric transducer 342, an input amplifier 344, a volume user interface 346, an analog to digital converter (ADC) 348, a summation unit 350, a band-pass filter array 352, a triggered acoustic modifying array 354, a DAC 356, an output amplifier 358, an electro-acoustic transducer 360, a waveform storage unit 362, a mode selection user interface 364, a processor 366, a physiological monitor 368 and an OAE profile source 370. Processor 366 includes an automatic gain controller (AGC) 372.

Volume user interface 346 is a device which enables a user (not shown), to adjust the volume of an ambient sound which system 340 produces in the vicinity of an ear 374. Mode selection user interface 364 is a device which enables the user to set system 340 at a selected operation mode. When the ambient sound includes sounds from different sources, for example, the noise of a running engine, music and speech, and the user desires to hear especially the speech, the user switches system 340 to the speech setting. Each one of volume user interface 346 and mode selection user interface 364 can be either tactile (e.g., in form of a manual potentiometer, a switch, a wireless or wired keypad or touch-screen), or audio (e.g., a wireless or wired voice recognition device), and the like. Band-pass filter array 352 includes a plurality of band-pass filters (not shown) similar to each of band-pass filters 242₁, 242₂ and 242_{N}, as described herein above in connection with FIG. 4A. Triggered acoustic modifying array 354 includes a plurality of triggered acoustic modifiers (not shown) similar to each of triggered acoustic modifiers 244₁, 244₂ and 244_{N}, as described herein above in connection, with FIG. 4A.

Physiological monitor 368 is a device which detects a physiological parameter of the body of a user, such as otoacoustic emissions of the ear, cardiac parameter (e.g., blood-pressure, blood flow rate, heart rate), respiration rate, basal body temperature, Brownian motion of a fluid contained in a cochlea of the ear, ion exchange rate of a nerve cell membrane of the cochlea which in turn initiates signal transmission along a nerve, and the like. OAE profile source 370 is a device which provides data respective of the OAE of an ear. OAE profile source 370 can be a device for measuring the OAE of an ear, a database which includes this data, and the like. The OAE can either be measured in the ear with which system 340 is used, or in another ear.

Input amplifier 344 is coupled with acousto-electric transducer 342, volume user interface 346 and with ADC 348. ADC 348 is coupled with summation unit 350 and with processor 366. Summation unit 350 is coupled with each of the band-pass filters of band-pass filter array 352 and with processor 366. Each of the triggered acoustic modifiers of triggered acoustic modifying array 354 is coupled with the respective band-pass-filter of band-pass filter array 352, with processor 366 and with DAC 356. Output amplifier 358 is coupled with DAC 356 and with electro-acoustic transducer 360. Processor 366 is coupled with waveform storage unit 362, mode selection user interface 364, physiological monitor 368 and with OAE profile source 370.

Acousto-electric transducer 342 detects an ambient sound, produces an analog ambient sound signal according to the detected ambient sound and provides the analog ambient sound signal to input amplifier 344. Amplifier produces an amplified ambient sound signal by amplifying the analog ambient sound signal and provides the amplified ambient sound signal to ADC 348. ADC 348 produces a: digital ambient sound signal by converting the amplified ambient sound signal from analog format to digital format and provides the digital ambient sound signal to summation unit 350.

The user selects a mode of operation of system 340 via mode selection user interface 364 and mode selection user interface 364 provides a mode signal to processor 366. For example, when the user selects the speech mode, processor 366 modifies the waveform stored in waveform storage unit 362 such that the amplitude of the waveform at the frequency range characteristic of speech, is higher than that of other frequencies.

Physiological monitor 368 monitors the physiological status of the user, such as fatigue, sleep, drowsiness, alertness, and the like, by detecting one or more physiological parameters of the body of the user, as described herein above. Physiological monitor 368 produces a physiological signal according to the detected physiological parameter and provides the physiological signal to processor 366 online (i.e., while system 340 is producing sounds for ear 374). Processor 366 modifies the waveform stored in waveform storage unit 362 according to the physiological signal. Thus, system 340 operates in real-time and is responsive to changes in the physiological status of the user.

For example, when a normally hearing body is asleep, the activation threshold of the inner hair cells and the outer hair cells increases and the ear is less responsive to ambient sound. To mimic the sleeping state of the ear in a hearing impaired body, processor 366 for example, increases the threshold of the respective triggered acoustic modifiers of triggered acoustic modifying array 354, according to the physiological signal. Alternatively, system 340 can operate offline, wherein processor 366 modifies the waveform stored in waveform storage unit 362, according to the physiological signal, while system 340 is not producing sounds for ear 374.

OAE profile source 370 produces an OAE signal by retrieving OAE data from a database, by detecting the OAE sounds of ear 374 or another ear (not shown), and the like. In case OAE profile source 370 retrieves OAE data from a database, processor 366 receives the OAE signal offline (i.e., when system 340 does not produce sounds for ear 374), processor 366 determines one or more waveforms according to the OAE signal and processor 366 stores the determined waveform in waveform storage unit 362.

In case OAE profile source 370 detects OAE sounds of an ear, processor 366 receives the OAE signal online (i.e., while system 340 is producing sounds for ear 374), and processor 366 modifies the waveform stored in waveform storage unit 362, according to the OAE signal. Thus, system 340 operates in real-time and is responsive to changes in the OAE pattern of ear 374.

Processor 366 determines a compensatory signal according to any of the waveform stored in waveform storage unit 362, the mode signal received from mode selection user interface 364, the physiological signal received from physiological monitor 368 and according to the OAE signal received from OAE profile source 370, or any combination thereof. Processor 366 provides the compensatory signal to summation unit 350. Summation unit 350 produces a combined ambient sound signal, by adding the digital ambient sound signal received from ADC 348, to the compensatory signal received from processor 366 and summation unit 350 provides the combined ambient sound signal to the band-pass filters of band-pass filter array 352.

Each of the band-pass filters of band-pass filter array 352 produces a filtered signal, as described herein above in connection with FIG. 4A and provides the filtered signal to the respective triggered acoustic modifier of triggered acoustic modifying array 354. Each of the triggered acoustic modifiers of triggered acoustic modifying array 354 produces a modified signal according to the respective filtered signal, as described herein above in connection with FIG. 4A and triggered acoustic modifying array 354 provides a combined modified signal to DAC 356.

DAC 356 produces an analog combined modified signal by converting the combined modified signal from digital format to analog format and provides the analog combined modified signal to output amplifier 358. Output amplifier 358 produces an amplified combined modified signal by amplifying the analog combined modified signal and provides the amplified combined modified signal to electro-acoustic transducer 360. Electro-acoustic transducer 360 produces a combined modified sound for ear 374, according to the combined modified signal.

AGC 372 determines an upper level threshold and a lower level threshold for each of the triggered acoustic modifiers of triggered acoustic modifying array 354 and processor 366 provides a threshold signal respective of the determined upper level threshold and the lower level threshold, to the respective triggered acoustic modifier. Thus, processor 366 sets the upper level threshold and the lower level threshold for each of the triggered acoustic modifiers. AGC 372 determines the upper level threshold and the lower level threshold, according to the SRT of ear 374, the volume of the ambient sound (i.e., the ambient sound signal received from ADC 348), the dynamic range of ear 374, and the like.

If the volume of the ambient sound rises, AGC 372 increases the threshold of the respective triggered acoustic modifier, in order to allow ear 374 to hear the ambient sound at this relatively higher volume. The amplitude of the modified signal is usually higher by approximately 10 dB than the threshold of the triggered acoustic modifier. For example, if the sound pressure level (SPL) of the ambient sound is 60 dB, AGC 372 sets the threshold of the respective triggered acoustic modifier to 50 dB, thereby allowing ear 374 to hear the modified sound produced by electro-acoustic transducer 360, at 60 dB.

Processor 366 adjusts the amplitude of the compensatory signal according to any of the determined upper level threshold, the determined lower level threshold, the mode signal received from mode selection user interface 364, the physiological signal received from physiological monitor 368, the waveform stored in waveform storage unit 362, the sensational level of ear 374, and the OAE signal received from OAE profile source 370, or any combination thereof. Processor 366 determines an ambient sound volume according to any of the determined upper level threshold and the lower level threshold, the mode signal received from mode selection user interface 364, the physiological signal received from physiological monitor 368, the waveform stored in waveform storage unit 362, the sensational level of ear 374, and the OAE signal received from OAE profile source 370, or any combination thereof. Processor 366 produces an ambient sound volume signal according to the determined ambient sound volume and provides the ambient sound volume signal to ADC 348. ADC 348 adjusts the amplitude of the digital ambient sound signal according to the ambient sound volume signal. For this purpose, ADC 348 includes a gain control unit (not shown).

Alternatively, processor 366 is coupled with input amplifier 344, processor 366 provides the ambient sound volume signal to input amplifier 344 and input amplifier 344 adjusts the amplitude of the ambient sound signal according to the ambient sound volume signal. For this purpose, input amplifier 344 can be a digital unit. In this case, the ADC is disposed of and the input amplifier is coupled directly with the summation unit. The user can adjust the volume of the ambient sound signal, via volume user interface 346.

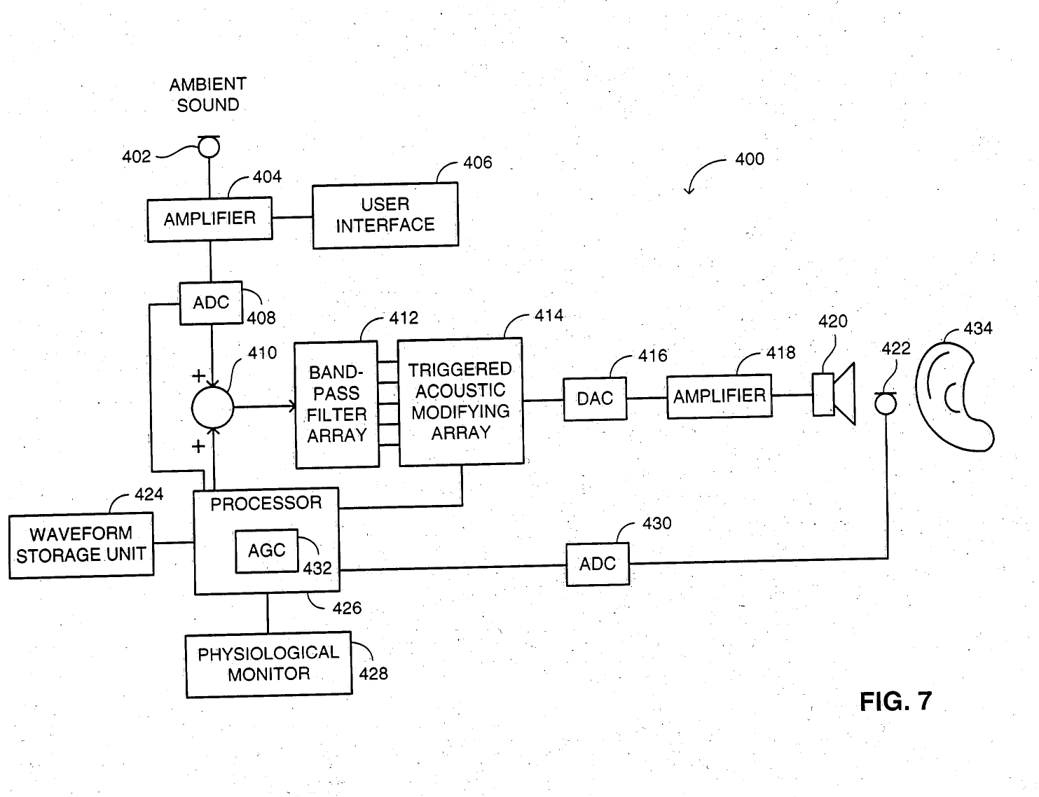

Reference is now made to FIG. 7, which is a schematic illustration of a system for enhancing hearing in a selected range of frequencies, generally referenced 400, constructed and operative in accordance with another embodiment of the disclosed technique. System 400 includes an ambient acousto-electric transducer 402, an input amplifier 404, a user interface 406, an ambient sound, ADC 408, a summation, unit 410, a band-pass filter array 412, a triggered acoustic modifying array 414, a DAC 416, an output amplifier 418, an electro-acoustic transducer 420, an ear acousto-electric transducer 422, a waveform storage unit 424, a processor 426, a physiological monitor 428 and an ear sound ADC 430. Processor 426 includes an AGC 432.

System 400 is similar to system 340 (FIG. 6), except that instead of OAE profile source 370, ear ADC 430 is coupled with processor 426 and with ear acousto-electric transducer 422. Acousto-electric transducer 422 detects the sounds in the vicinity or an ear 434, wherein these sounds include the sound produced by electro-acoustic transducer 422, as well as the OAE sounds produced by the outer hair cells (not shown) of ear 434.

Acousto-electric transducer 422 produces an ear sound signal respective of the detected sound and provides the ear sound signal to ear ADO 430. Ear ADC 430 produces a digital ear sound signal by converting the ear sound signal from analog format to digital format and provides the digital ear sound signal to processor 426.

Processor 426 determines the OAE portion of the ear sound signal, according to the digital ear sound signal received from ear ADC 430, the digital ambient sound signal received from ambient ADO 408 and according to the waveform stored in waveform storage unit 424. Processor 426 produces a compensatory signal according to any of the determined OAE portion of the ear sound signal, the waveform stored in waveform storage unit 424, the upper level threshold and the lower level threshold determined by AGC 432 and the physiological signal received from physiological monitor 428, or any combination thereof. Processor 426 determines an ambient sound volume for the ambient sound signal, according to any of the determined OAE portion of the ear sound signal, the waveform stored in waveform storage unit 424, the upper level threshold and the lower level threshold determined by AGC 432 and the physiological signal received from physiological monitor 428, or any combination thereof. Processor 426 adjusts the volume of the compensatory signal according to any of the determined OAE portion of the ear sound signal, the upper level threshold and the lower level threshold determined by AGC 432 and the physiological signal received from physiological monitor 428 or any combination thereof.

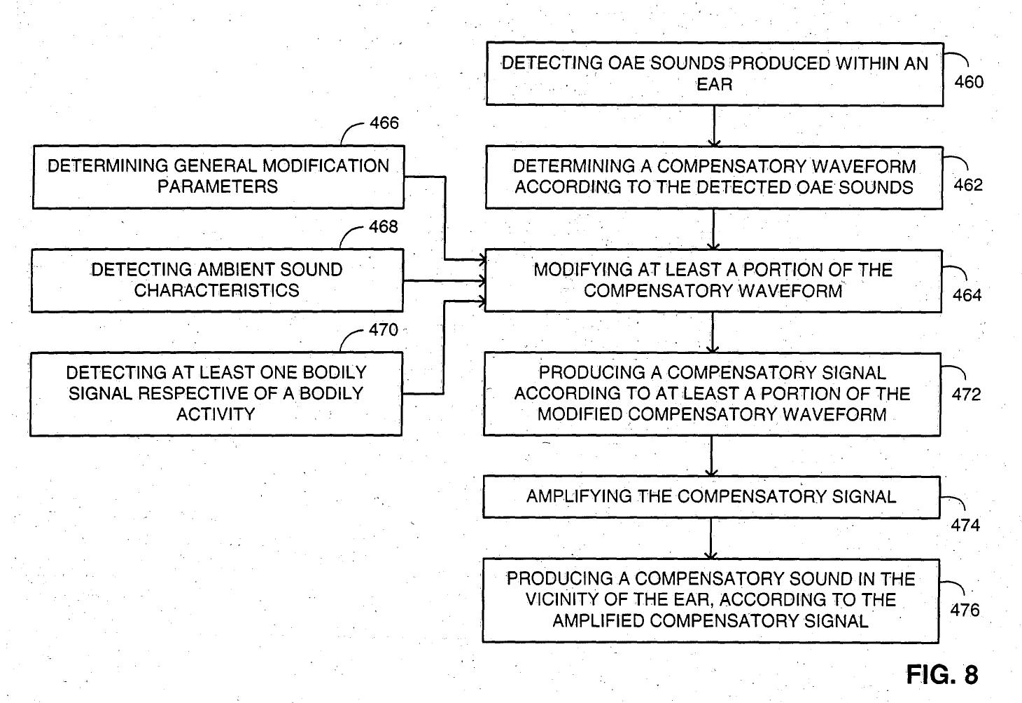

Reference is now made to FIG. 8, which is a schematic illustration of a method for operating the system of FIG. 1., operative in accordance with a further embodiment of the disclosed technique. In procedure 460, OAE sounds which are produced within an ear, are detected. The OAE sounds can be detected for example, by ear acousto-electric transducer 422 (FIG. 7). The OAE sounds can be detected from the same ear for which the compensatory sound is produced in procedure 476, as described herein below. Alternatively, the OAE sounds are detected from an ear other than the one for which the compensatory sound is produced in procedure 0.476. Further alternatively, the OAE sounds can be obtained by statistical measurements, such as hearing tests, and the like.

In procedure 462, a compensatory waveform is determined according to the detected OAE sounds. With reference to FIG. 2C, an OAE profile source similar to OAE profile source 370 (FIG. 6), detects abnormal-OAE waveform 126 of an abnormal ear, and processor 110 (FIG. 1) determines compensatory OAE waveform 128, according to detected abnormal-OAE waveform 126.

In procedure 464, at least a portion of the compensatory waveform is modified. The compensatory waveform can be modified for example, according to any of procedures 466, 468 and 470, or any combination thereof. With reference to FIGS. 1, 2C and 2D, processor 110 determines modified compensatory OAE waveform 128 by modifying compensatory OAE waveform 132 such that the hearing spectrum of abnormal ear 114 is similar to line 130. Processor 110 stores modified compensatory OAE waveform 128 in waveform storage unit 108.

In procedure 466, general modification parameters are determined. With reference to FIG. 6, the user selects an operation mode for system 340 via mode selection user interface 364. In this manner, processor 366 receives a mode signal from mode selection user interface 364, respective of modification parameters for modifying the compensatory waveform, as determined in procedure 462. Alternatively, these modification parameters are permanently stored in processor 366, and thus system 340 operates in a unique mode, all the time.

In procedure 468, ambient sound characteristics are detected. With reference to FIG. 6, a plurality of sampled sound characteristics are stored in waveform storage unit 362. Processor 366 receives an ambient sound signal from ADC 348 and processor 366 produces ambient sound characteristics according to the ambient sound signal. Processor 366 compares the ambient sound characteristics with the sampled sound characteristics and selects a set of sampled sound characteristics which substantially matches the ambient sound characteristics.

For example, if the ambient sound is that of a symphony orchestra, processor 366 compares the characteristics of the symphony orchestra with the sampled sound characteristics and selects a set of sampled sound characteristics which best matches the characteristics of the symphony orchestra. Processor 366 modifies the compensatory waveform, as determined in procedure 462, according to the selected set of sampled sound characteristics. This modified compensatory waveform can eventually cause system 340 to produce a combined modified sound, such that ear 374 for example, will hear the sounds of the violin better than the sounds of the cello.

In procedure 470, at least one bodily signal respective of a bodily activity is detected. With reference to FIG. 6, physiological monitor 368 detects a physiological parameter of the user, produces a physiological signal according to the detected physiological parameter and provides the physiological signal to processor 366. Processor 366 modifies the compensatory waveform, as determined in procedure 462, according to the physiological signal.

In procedure 472, a compensatory signal is produced according to at least a portion of the modified compensatory waveform. With reference to FIG. 1, processor 110 retrieves the modified compensatory waveform from waveform storage unit 108 and processor 110 produces a compensatory signal according to the modified compensatory waveform.

In procedure 474, the compensatory signal is amplified. With reference to FIG. 1, amplifier 104 produces an amplified compensatory signal, by amplifying the compensatory signal and provides the amplified compensatory signal to electro-acoustic transducer 106.

In procedure 476, a compensatory sound is produced in the vicinity of the ear, according to the amplified compensatory signal. With reference to FIG. 1, electro-acoustic transducer 106 produces a compensatory sound, according to the amplified compensatory signal. The compensatory sound causes the ear to hear the ambient sound better and more clearly.

According to a further aspect of the disclosed technique, a modified signal whose frequency is different than that of an input signal, is produced when the energy of the input signal is substantially equal to or greater than a threshold, by activating a switch. Although the modified signal is distorted relative to the input signal, the amplitude of the modified signal is high enough to be detected by an ear.

Reference is now made to FIG. 9, which is a schematic illustration of a system for producing a modified signal, generally referenced 500, constructed and operative in accordance with another embodiment of the disclosed technique. System 500 includes an acousto-electric transducer 502, a band-pass filter array 504, a processor 506, a triggered acoustic modifying (TAM) array 508 and an electro-acoustic transducer 510. Band-pass filter array 504 includes a plurality of band-pass filters 512₁ and 512_{N} TAM array 508 includes a plurality of triggered acoustic modifiers 514₁ and 514_{N}

Band-pass filters 512₁ and 512_{N} are coupled with acousto-electric transducer 502 and with processor 506. Band-pass filters 512₁ and 512_{N} are coupled with triggered acoustic modifiers 514₁ and 514_{N}, respectively. Processor 506 is coupled with triggered acoustic modifiers 514₁ and 514_{N} Triggered acoustic modifiers 514₁ and 514_{N} are coupled with electro-acoustic transducer 510.

Acousto-electric transducer 502 detects the ambient sound, produces an ambient sound signal according to the detected ambient sound and provides the ambient sound signal to band-pass filters 512₁ and 512_{N}. Band-pass filters 512₁ and, 512N produce filtered ambient sound signals 516₁ and 516_{N}, respectively, and provide filtered ambient sound signals 516₁ and 516_{N} to processor 506. Processor 506 determines one or more compensatory signals according to filtered ambient sound signals 516₁ and 516_{N}, combines each compensatory signal with the respective filtered ambient sound signal, and produces combined ambient sound signals 518₁ and 518_{N}.

Combined ambient sound signals 518₁ and 518_{N} are distorted relative to filtered ambient sound signals 516₁ and 516_{N}, respectively (e.g., in terms of frequency or phase). Thus, the necessary condition of signal distortion for stochastic resonance to take place, is satisfied. Processor 506 provides combined ambient sound signals 518₁ and 518N to triggered acoustic modifiers 514₁ and 514_{N}, respectively. Alternatively, the signal distortion is performed by other elements of system 500 as part of normal operation of system 500.

Each of triggered acoustic modifiers 514, and 514_{N} includes a triggering module (not shown). The triggering module of triggered acoustic modifiers 514₁ and 514_{N} receive filtered ambient sound signals 516₁ and 516_{N}, respectively. These triggering modules are switched on, when the energy of each of filtered ambient sound signals 516₁ and 516_{N}, is substantially equal to or greater than a threshold. Thus, the triggering modules enable triggered acoustic modifiers 514₁ and 514_{N} to produce modified signals 520₁ and 520_{N}, respectively, according to filtered ambient sound signals 516₁ and 516_{N}, respectively. Hence, another necessary condition of signal triggering for stochastic resonance to take place, is satisfied.

Triggered acoustic modifying array 508 produces a combined modified signal by combining modified signals 520₁ and 520_{N} and provides the combined modified signal to electro-acoustic transducer 510. Electro-acoustic transducer 510 produces a modified sound in the vicinity of an ear 522, according to the combined modified signal.

Reference is now made to FIG. 10, which is a schematic illustration of a system for producing a modulated signal, generally referenced 550, constructed and operative in accordance with a further embodiment of the disclosed technique. System 550 includes an acousto-electric transducer 552, a band-pass filter array 554, a processor 556, modulating array 558 and an electro-acoustic transducer 560. Band-pass filter array 554 includes a plurality of band-pass filters 562₁ and 562_{N}. Modulating array 558 includes a plurality of modulators 564₁ and 564_{N}.

Band-pass filters 562₁ and 562_{N} are coupled with acousto-electric transducer 552 and with processor 556. Processor 556 is coupled with modulators 564₁ and 564_{N}. Modulators 564₁ and 564_{N} are coupled with electro-acoustic transducer 560.

Acousto-electric transducer 552 detects the ambient sound, produces an ambient sound signal according to the detected ambient sound and provides the ambient sound signal to band-pass filters 562, and 562_{N}. Band-pass filters 562₁ and 562_{N} produce filtered ambient sound signals 566₁ and 566_{N}, respectively, and provide filtered ambient sound signals 566₁ and 566_{N} to processor 556.

Processor 556 determines compensatory signals 568₁ and 568_{N} according to filtered ambient sound signals 566₁ and 566_{N}, respectively. Processor 556 compares the energy of each of filtered ambient sound signals 566₁ and 566_{N} with a respective threshold, and when processor 556 determines that the respective energy level is substantially equal to or greater than the respective threshold, processor 556 provides compensatory signals 568₁ and 568_{N} to modulators 564₁ and 564_{N}, respectively.

Modulator 564₁ receives filtered ambient sound signal 566₁ and compensatory signal 568₁, and produces modulated signal 570₁ by modulating filtered ambient sound signal 566₁ with compensatory signal 568₁. Modulator 564_{N} receives filtered ambient sound signal 566_{N} and compensatory signal 568_{N}, and produces modulated signal 570_{N} by modulating filtered ambient sound signal 566_{N} with compensatory signal 568_{N}.

Modulated signals 570₁ and 570_{N} are distorted relative to filtered ambient sound signals 566₁ and 566_{N}, respectively. Furthermore, processor 556 enables modulators 564₁ and 564_{N}, only when the energy of each of filtered ambient sound signals 566₁ and 566_{N}, respectively, is substantially equal to or greater than the respective threshold. Thus, the necessary conditions of signal distortion and signal triggering for stochastic resonance to take place, are satisfied.

Modulating array 558 produces a combined modulated signal by combining modulated signals 570₁ and 570_{N}, provides the combined modulated signal to electro-acoustic transducer 560. Electro-acoustic transducer 560 produces a combined modulated sound in the vicinity of an ear 572, according to the combined modulated signal.

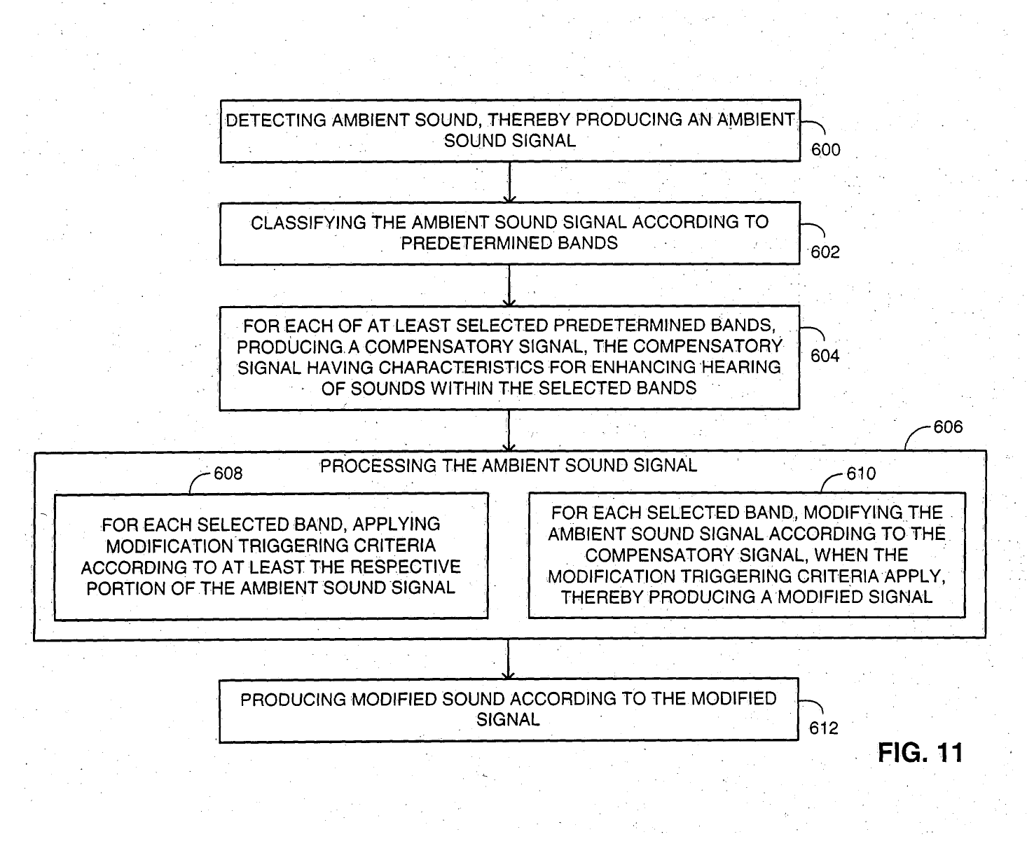

Reference is now made to FIG. 11, which is a schematic illustration of a method for enhancing hearing in a selected range of frequencies, operative in accordance with another embodiment of the disclosed technique. In procedure 600, an ambient sound is detected, thereby producing an ambient sound signal. With reference to FIG. 4A, acousto-electric transducer 234 detects the ambient sound and produces an ambient sound signal according to the detected ambient sound.

In procedure 602 the ambient sound signal is classified according to predetermined bands. With reference to FIGS. 4B and 10, bands 272₁ and 272_{N} are associated with band-pass filters 562₁ and 562_{N}, respectively, and band-pass filters 562, and 562_{N} produce filtered ambient sound signals 566₁ and 566_{N}, respectively, by filtering the ambient sound signal.

In procedure 604, a compensatory signal is produced for each of at least selected predetermined bands, the compensatory signal having characteristics for enhancing hearing of sounds within the selected bands. With reference to FIGS. 4B and 10, processor 556 produces compensatory signals 568, and 568_{N}, for band-pass filters 562, and 562_{N}, respectively (i.e., bands 272₁ and 272_{N}, respectively). With reference to FIGS. 1, 2B and 2C, processor 110 determines compensatory OAE waveform 128, such that the hearing spectrum of abnormal ear 114, is corrected from abnormal-hearing spectrum 124 to normal hearing spectrum 120.

It is noted that procedure 604 can be performed before procedure 602. For example, according to FIG. 4A, compensatory signal generator 232 produces a compensatory signal (procedure 604). Band-pass filters 242₁, 242₂ and 242_{N} filter combined signal 270 (i.e., a combination of the compensatory signal and the ambient sound signal), and produce filtered signals 252₁, 252₂ and 252_{N}, respectively (procedure 602).

In procedure 606, the ambient sound is processed. Procedure 606 includes two sub-procedures 608 and 610. In procedure 608, modification triggering criteria are applied for each selected band, according to at least the respective portion of the ambient sound signal. The modification triggering criteria can include for example, that the energy of the ambient sound signal be substantially equal to or greater than a threshold. With reference to FIG. 10, processor 556 provides compensatory signal 568₁ to modulator 564₁, when processor 556 determines that the energy of filtered ambient sound signal 566₁ is substantially equal to or greater than the respective threshold.

According to another example, the modification triggering criterion dictates that the combined energy of the ambient sound signal and the compensatory signal, be equal to or substantially greater than a threshold. With reference to FIG. 4A, triggered acoustic modifier 244, produces modified signal 254₁, when the energy of filtered signal 252, (i.e., a combination of the ambient sound signal and the compensatory signal), is substantially equal to or greater than the threshold.

In procedure 610, of the ambient sound signal is modified according to the compensatory signal, for each selected band, when the modification triggering criteria apply, thereby producing a modified signal. With reference to FIG. 6, summation unit 350 produces a modified signal, by adding the ambient sound signal received from ADC 348, to the compensatory signal received from processor 366. With reference to FIG. 10, modulator 564₁ produces modulated signal 570₁ by modulating filtered ambient sound signal 566₁ with compensatory signal 568₁. The modification triggering criteria are applied to filtered ambient sound signal 566₁ by processor 556.

It is noted that compensatory signal 568₁ is of such a characteristic that when modulated with filtered ambient sound signal 566₁, modulated signal 570₁ is a distorted form of the ambient sound. Thus, it is possible to produce for example, a pseudo low frequency psychoacoustic sensation of the ambient sound for ear 572, according to a compensatory signal whose frequency is far beyond the audible range of frequencies.

With reference to FIG. 9, triggered acoustic modifier 514₁ produces modified signal 520₁ according to combined ambient sound signal 518₁, when the energy of filtered ambient sound signal 516₁ is substantially equal to or greater than a threshold. Due to the operation of triggered acoustic modifier 514₁, the frequency spectrum of modified signal 520₁ is different than that of filtered ambient sound signal 516₁ (i.e., filtered ambient sound signal 516₁ is modified). It is noted that procedure 608 can be performed either before or after procedure 610.

In procedure 612, a modified sound is produced according to the modified signal. With reference to FIG. 4A, electro-acoustic transducer 240 produces a combined modified sound for ear 50, according to combined modified signal 276.

It will be appreciated by persons skilled in the art that the disclosed technique is not limited to what has been particularly shown and described hereinabove. Rather the scope of the disclosed technique is defined only by the claims, which follow.

1. System for enhancing the hearing of certain sounds, the system comprising:
an electro-acoustic transducer for producing sounds in the vicinity of an ear, according to signals provided thereto; and
a compensatory signal generator coupled with said electro-acoustic transducer, said compensatory signal generator producing a compensatory signal, according to at least a portion of a compensatory waveform, said compensatory waveform being determined according to ear otoacoustic emissions, said compensatory signal being employed to enhance said hearing, said compensatory signal generator providing said compensatory signal to said electro-acoustic transducer.

2. The system according to claim 1, further comprising an electro-acoustic amplifier coupled between said compensatory signal generator and said electro-acoustic transducer,
wherein said electro-acoustic amplifier produces an amplified compensatory signal by amplifying said compensatory signal, and
wherein said electro-acoustic amplifier provides said amplified compensatory signal to said electro-acoustic transducer.

3. The system according to claim 1, wherein said compensatory signal generator comprises:
a waveform storage unit for storing said compensatory waveform;
a processor coupled with said waveform storage unit, said processor producing said compensatory signal according to at least a portion of said compensatory waveform; and
a digital to analog converter coupled between said processor and said amplifier, said digital to analog converter converting said compensatory signal from digital format to analog format.

4. The system according to claim 1, further comprising an ambient acousto-electric transducer coupled with said electro-acoustic transducer, wherein said ambient acousto-electric transducer further produces an ambient sound signal respective of an ambient sound.

5. The system according to claim 4, further comprising an ambient sound amplifier coupled with said ambient acousto-electric transducer and with said electro-acoustic transducer,
wherein said ambient sound amplifier produces an amplified ambient sound signal by amplifying said ambient sound signal, and
wherein said ambient sound amplifier provides said amplified ambient sound signal to said electro-acoustic transducer.

6. The system according to claim 5, further comprising a volume user interface coupled with said ambient sound amplifier, said volume user interface being employed to vary an ambient sound signal amplitude of said ambient sound signal.

7. The system according to claim 1, further comprising:
an ambient acousto-electric transducer producing an ambient sound signal according to an ambient sound;
at least one band-pass filter, each of said at least one band-pass filter being coupled with said compensatory signal generator and with said ambient acousto-electric transducer, each of said at least one band pass filter being associated with a respective predetermined band; and
at least one triggered acoustic modifier, each of said at least one triggered acoustic modifier being coupled with a respective one of said at least one band-pass filter, and with said electro-acoustic transducer,
wherein each of said at least one band-pass filter, filters signals provided thereto according to said respective predetermined band and provides a band filtered signal to said respective triggered acoustic modifier,
wherein said at least one triggered acoustic modifier produces a modified signal by modifying said band filtered signal, when modification triggering criteria apply,
wherein said at least one triggered acoustic modifier provides said modified signal to said electro-acoustic transducer, and
wherein said at least one triggered acoustic modifier ceases to produce said modified signal, when said modification triggering criteria cease to apply.

8. The system according to claim 7, wherein said modification triggering criteria is selected from the list consisting of:
an ambient sound energy of said ambient sound signal to be greater than an upper level threshold and a lower level threshold;
a combined energy of a combination of said ambient sound signal and said compensatory signal to be greater than said upper level threshold and said lower level threshold;
said ambient sound energy to be greater than a threshold; and
said combined energy to be greater than said threshold.

9. The system according to claim 8, wherein each of said upper level threshold and said lower level threshold, is different for different ones of said at least one triggered acoustic modifier.

10. The system according to claim 8, wherein the amplitude of each of said ambient sound signal and said compensatory signal, is less than said upper level threshold.

11. The system according to claim 7, wherein each of said at least one band-pass filter is respective of a different critical band of said ear.

12. The system according to claim 7, wherein said compensatory signal generator comprises:
a waveform storage unit for storing said compensatory waveform; and
a processor coupled with said waveform storage unit, with each of said at least one band-pass filter and with each of said at least one triggered acoustic modifier, said processor producing said compensatory signal according to at least a portion of said compensatory waveform,
wherein said processor determines at least one value for said modification triggering criteria, and
wherein said processor provides a modification triggering signal respective of said at least one determined value, to said at least one triggered acoustic modifier.

13. The system according to claim 12, further comprising an ambient analog to digital converter coupled with said ambient acousto-electric transducer, said processor, and with said at least one band-pass filter,
wherein said ambient analog to digital converter produces a digital ambient sound signal, by converting said ambient sound signal from analog format to digital format,
wherein said processor determines an ambient sound amplitude of said ambient sound signal, and
wherein said processor provides an ambient sound amplitude signal respective of said determined ambient sound amplitude, to said ambient analog to digital converter.

14. The system according to claim 7, further comprising a digital to analog converter coupled between said electro-acoustic transducer and said at least one triggered acoustic modifier,
wherein said digital to analog converter produces an analog modified signal, by converting said modified signal from digital format to analog format, and
wherein said digital to analog converter provides said analog modified signal to said electro-acoustic transducer.

15. The system according to claim 1, further comprising a physiological monitor coupled with said compensatory signal generator and with at least a portion of the body of a user,
wherein said physiological monitor detects a physiological parameter of said user,
wherein said physiological monitor provides a physiological signal respective of said detected physiological parameter to said compensatory signal generator, and
wherein said compensatory signal generator produces said compensatory signal according to said physiological signal and at least a portion of said compensatory waveform.

16. The system according to claim 15, wherein said physiological parameter is selected from the list consisting of:
said ear otoacoustic emissions;
cardiac parameter;
respiration rate;
basal body temperature;
Brownian motion of a fluid contained in a cochlea of an ear of said user; and
ion exchange rate of a cell membrane of said cochlea.

17. The system according to claim 1, further comprising an otoacoustic emissions profile source coupled with said compensatory signal generator, wherein said otoacoustic emissions profile source provides at least one otoacoustic emissions profile to said compensatory signal generator, and
wherein said compensatory signal generator produces said compensatory signal according to said at least one otoacoustic emissions; profile and at least a portion of said compensatory waveform.

18. The system according to claim 1, further comprising an otoacoustic acousto-electric transducer coupled with said compensatory signal generator, said otoacoustic acousto-electric transducer detecting said ear otoacoustic emissions,
wherein said otoacoustic acousto-electric transducer provides an otoacoustic emissions signal respective of said detected ear otoacoustic emissions, to said compensatory signal generator, and
wherein said compensatory signal: generator produces said compensatory signal according to said otoacoustic emissions signal and at least a portion of said compensatory waveform.

19. The system according to claim 1, further comprising a mode selection user interface coupled with said compensatory signal generator, said mode selection user interface being employed for setting said system at a selected operating mode.

20. The system according to claim 1, wherein at least a portion of said compensatory waveform is substantially anti-phase relative to at least another portion of an otoacoustic emissions waveform of said ear otoacoustic emissions, and
wherein at least a portion of said sounds is substantially anti-phase relative to at least another portion of an otoacoustic emissions sound produced by said ear.

21. Method for enhancing the hearing of certain sounds, the method comprising the procedures of:
producing a compensatory signal according to at least a portion of a compensatory waveform, said compensatory signal being employed to enhance said hearing, said compensatory waveform being determined according to ear otoacoustic emissions; and
producing a compensatory sound in the vicinity of said ear, according to said compensatory signal.

22. The method according to claim 21, further comprising a preliminary procedure of modifying at least a portion of said compensatory waveform.

23. The method according to claim 22, wherein said procedure of modification comprises a sub-procedure of determining general modification parameters.

24. The method according to claim 22, wherein said procedure of modification comprises a sub-procedure of detecting ambient sound characteristics.

25. The method according to claim 22, wherein said procedure of modification comprises a sub-procedure of detecting at least one bodily signal respective of a bodily activity.

26. The method according to claim 25, wherein said bodily activity is selected from the list consisting of:
said ear otoacoustic emissions;
cardiac activity;
respiration rate;
basal body temperature;
Brownian motion of a fluid contained in a cochlea of an ear; and
ion exchange rate of a cell membrane of said cochlea.

27. The method according to claim 21, further comprising a preliminary procedure of determining said compensatory waveform according to otoacoustic emissions sounds, before performing said procedure of producing said compensatory signal.

28. The method according to claim 27, further comprising a procedure of storing said compensatory waveform.

29. The method according to claim 27, wherein said otoacoustic emissions sounds are produced according to otoacoustic emissions selected from the list consisting of:
spontaneous otoacoustic emissions;
distortion product otoacoustic emissions; and
transient-evoked otoacoustic emissions.

30. The method according to claim 27, further comprising a preliminary procedure of detecting said otoacoustic emissions sounds.

31. The method according to claim 21, further comprising a procedure of amplifying said compensatory signal, after performing said procedure of producing said compensatory signal.

32. The method according to claim 21, further comprising a procedure of converting said compensatory signal from digital format to analog format, after performing said, procedure of producing said compensatory signal.

33. The method according to claim 21, further comprising a procedure of producing an ambient sound signal by detecting ambient sound, before performing said procedure of producing said compensatory sound, wherein said compensatory sound is produced according to a combination of said compensatory signal and said ambient sound signal.

34. The method according to claim 33, further comprising a procedure of amplifying said ambient sound signal.

35. The method according to claim 21, wherein at least a portion of said compensatory waveform is substantially anti-phase relative to at least another portion of an otoacoustic emissions waveform of said ear otoacoustic emissions.

36. The method according to claim 21, wherein said compensatory signal is produced according to frequencies selected from the list consisting of:
frequencies within an otoacoustic emissions waveform of said ear otoacoustic emissions;
frequencies between two adjacent frequencies within said otoacoustic emissions waveform; and
frequencies within and outside of said otoacoustic emissions waveform.

37. Method for enhancing the hearing of certain sounds, the method comprising the procedures of:
producing a compensatory signal for at least selected ones of a plurality of predetermined bands, said compensatory signal having characteristics for enhancing hearing of sounds within said selected predetermined bands;
applying modification triggering criteria corresponding to each of said selected predetermined bands, according to at least a respective portion of an ambient sound signal; and
modifying said ambient sound signal corresponding to each of said selected predetermined bands, according to said compensatory signal, when said modification triggering criteria apply, thereby producing a modified signal.

38. The method according to claim 37, further comprising a preliminary procedure of classifying said ambient sound signal according to said predetermined bands.

39. The method according to claim 37, further comprising a preliminary procedure of detecting ambient sound, thereby producing said ambient sound signal.

40. The method according to claim 37, further comprising a procedure of producing modified sound according to said modified signal.

41. The method according to claim 37, wherein each of said predetermined bands corresponds with a different critical band of an ear.

42. The method according to claim 37, wherein said modification triggering criteria is selected from the list consisting of:
enabling modification of said ambient sound signal when an ambient sound energy of said ambient sound signal is greater than an upper level threshold, and disabling said modification when said ambient sound energy is lower than a lower level threshold;
enabling said modification when said ambient sound energy is greater than a threshold and disabling said modification when said ambient sound energy is lower than said threshold;
enabling said modification when a combined energy of a combination of said ambient sound signal and said compensatory signal is greater than said upper level threshold, and disabling said modification when said combined energy is lower than said lower level threshold; and
enabling said modification when said combined energy is greater than said threshold and disabling said modification when said combined energy is lower than said threshold.

43. The method according to claim 42, further comprising a procedure of controlling the value of each of said upper level threshold and said lower level threshold.

44. The method according to claim 42, further comprising a procedure of controlling the value of said threshold.

45. The method according to claim 42, further comprising a procedure of setting the amplitude of said ambient sound signal, according to said upper level threshold and said lower level threshold.

46. The method according to claim 42, further cqmprising a procedure of setting the amplitude of said compensatory signal, according to said upper level threshold and said lower level threshold.

47. The method according to claim 42, wherein each of said upper level threshold and said lower level threshold is determined according to criteria selected from the list consisting of:
speech recognition threshold of an ear;
amplitude of said ambient sound signal, and
dynamic range of said ear.

48. The method according to claim 37, wherein said procedure of modification includes sub-procedures selected from the list consisting of:
adding said respective portion to said compensatory signal corresponding with a respective one of said selected predetermined bands; and
modulating said respective portion with said compensatory signal corresponding with said respective selected predetermined band.

49. The method according to claim 48, further comprising a procedure of amplifying the amplitude of at least a portion of said respective portion, by inducing stochastic resonance in said respective portion.

50. The method according to claim 37, wherein said ambient sound signal is selected from the list consisting of:
wired communication system signal;
wireless communication system signal;
broadcast television signal;
broadcast radio signal;
unicast communication signal;
multicast communication signal;
anycast communication signal;
pre-stored retrieved signal; and
machine generated signal.

51. The method according to claim 37, further comprising a preliminary procedure of controlling the amplitude of said ambient sound signal, via a volume user interface.

52. The method according to claim 37, wherein the amplitude of each of said ambient sound signal and said compensatory signal is determined according to, parameters selected from the list consisting of:
physiological status of a user;
compensatory waveform determined according to ear otoacoustic emissions;
sensational level of an ear;
said ear otoacoustic emissions; and
a combination thereof.

53. The method according to claim 52, wherein said physiological status is determined by monitoring a bodily activity selected from the list consisting of:
said ear otoacoustic emissions;
cardiac activity;
respiration rate;
basal body temperature;
Brownian motion of a fluid contained in a cochlea of an ear; and
ion exchange rate of a cell membrane of said cochlea.

54. The method according to claim 37, further comprising a preliminary procedure of receiving a user selection of a mode for enhancing hearing of said sounds, via a mode selection user interface.

55. The method according to claim 54, wherein the amplitude of each of said ambient sound signal and said compensatory signal is determined according to said user selected mode.

56. The method according to claim 37, wherein the amplitude of each of said compensatory signal and said ambient sound signal, is determined according to an ear otoacoustic emissions portion of general sounds detected in the vicinity of an ear,
wherein said general sounds include said ear otoacoustic emissions portion.

57. The method according to claim 37, further comprising a procedure of converting said modified signal from digital format to analog format.
